(19) United States
(12) Patent Application Publication
(10) Pub. No.: US 2016/0041957 A1
(43) Pub. Date: Feb. 11, 2016

(54) SYSTEM AND METHOD FOR IMPROVING DESIGN OF USER DOCUMENTS

(71) Applicant: Cimpress Schweiz GmbH, Winterthur (CH)

(72) Inventors: Joseph Charles Finsterwald, Somerville, MA (US); Osi M. Peters, South Easton, MA (US); David F. Todd, Bedford, MA (US); Zachary Ross Lynn, Lexington, MA (US)

(73) Assignee: CIMPRESS SCHWEIZ GMBH, Winterthur (CH)

(21) Appl. No.: 14/819,295

(22) Filed: Aug. 5, 2015

Related U.S. Application Data
(60) Provisional application No. 62/033,175, filed on Aug. 5, 2014.

(51) Int. Cl. G06F 17/24; G06F 17/30; G06F 3/0484; G06F 17/21

(52) U.S. Cl. CPC G06F 17/24; G06F 17/212; G06F 17/30011; G06F 3/0484

(57) ABSTRACT

Visual design improvement suggestion systems, methods and user interfaces for design tools implement analysis and improvement of a visual design represented in an electronic document. Independent suggestion providers analyze and determine improvement suggestions for format and design aspects based on the format and content of the visual design. In a user interface, a user is presented with design improvement suggestions, and in an exemplary embodiment may indicate acceptance of the design improvement suggestion to instruct automatic application of the design improvement suggest to the visual design.

### CROSS REFERENCE TO RELATED APPLICATIONS

This application claims priority under 35 U.S.C. §119(e) of U.S. Patent Application No. 62/033,175, filed Aug. 5, 2014, which is hereby incorporated by reference in its entirety.

The present invention pertains generally to computer-assisted document design, and more particularly, to systems and methods for the analysis of the design and for dynamic determination, presentation, and application to the design of improvement suggestions related to the design.

### BACKGROUND OF THE INVENTION

Visual art and design holds an important place in business and entertainment-related activities. In business, the visual aspects of a design of a document, advertisement, or other promotional or marketing material, can have an enormous impact on the success or failure of a campaign or project. The visual design of documents, advertisements, marketing materials, etc., used in connection with the promotion of a business, its products and/or services, its promotional events or activities, etc., can enhance or detract from the message(s) sought to be imparted by the materials. From a business perspective, it is therefore important that the visual designs used on such documents and materials enhances rather than detracts from the intended purpose and message of the documents/materials.

Various technologies exist to assist in the creation of visual designs. Computer-assisted document design software generally provides a work area displayed on a computer or other electronic display, along with user-manipulable graphical user interface tools that allow a user to select, insert, modify, edit, move, remove, and otherwise manipulate graphical objects including text, images, graphical objects, layouts, color schemes, font schemes, backgrounds, special effects, etc., in the work area. While these types of tools can assist a user in creating a professional-looking document or design, nonetheless the professionalism of the visual look-and-feel of the final product depends in the end on how well the final design adheres to universally-accepted good visual design principles.

### SUMMARY

Embodiments of the invention include computer-automated design suggestion systems, methods, and user interfaces for providing and implementing visual design improvement suggestions based on the format and content of a received visual design.

In an embodiment, a system includes at least one receiving processor which receives an electronic document representing a visual design, and at least one analysis processor which analyzes the visual design to identify one or more design improvement suggestions for the visual design, and generates an indication of at least one of the design improvement suggestions, the design improvement suggestions comprising at least one of a format improvement suggestion determined from the format of the visual design and a design content improvement suggestion determined from the content of the visual design.

In another embodiment, a design tool for creating visual designs includes a user interface processor which presents a user interface on an electronic display, the user interface comprising a work area which displays a visual design, at least one editing control allowing a user to edit the visual design, and a design assistant area responsive to a suggestion processor to receive and display at least one design improvement suggestion. The suggestion processor is configured to analyze the visual design displayed in the work area to identify one or more design improvement suggestions for the visual design, and to generate an indication of at least one of the design improvement suggestions, the design improvement suggestions comprising at least one of a format improvement suggestion determined from the format of the visual design and a design content improvement suggestion determined from the content of the visual design.

In yet another embodiment, a design improvement suggestion system for analyzing a visual design represented in an electronic document includes electronic storage memory storing the electronic document, at least one suggestion engine processor executing a suggestion engine process which invokes one or more suggestion provider processes, and at least one suggestion provider processor. The at least one suggestion provider processor executes one or more of the invoked suggestion provider processes, each invoked suggestion provider process independently analyzing the visual design and measuring the visual design against different respective sets of one or more of design aspects to determine possible design improvements relative to the respective set of design aspects and to generate corresponding design improvement suggestions associated with the determined possible design improvements. The at least one suggestion engine selects at least one design improvement suggestion generated by the invoked suggestion provider processes and generates an indication of the selected at least one design improvement suggestion.

### BRIEF DESCRIPTION OF THE DRAWINGS

FIG. 1 is a schematic block diagram of an exemplary design suggestion tool implemented in accordance with the principles of the invention.

FIG. 2 illustrates an exemplary embodiment of a prior art user interface.

FIG. 3 illustrates an exemplary embodiment of a user interface which incorporates various embodiments of the invention.

FIG. 4 is a schematic block diagram of an exemplary environment in which embodiments of the invention may operate.

FIGS. 5A-5C are use case diagrams which together illustrate a use case for a suggestion provider which detects a text overlap condition in a user's design document and generates a corresponding remediation suggestion for the text overlap condition.

FIGS. 6A-6C are use case diagrams which together illustrate a use case for a suggestion provider which detects a poor text alignment condition in a user's design document and generates a corresponding remediation suggestion for the poor text alignment condition.

FIGS. 7A-7C are use case diagrams which together illustrate a use case for a suggestion provider which provides a suggestion for implementing a color variation for a user's design.

FIGS. 8A-8C are use case diagrams which together illustrate a use case for a suggestion provider which detects a poor text contrast condition in a user's design document and generates a corresponding remediation suggestion for the poor text contrast condition.

FIGS. 9A-9C are use case diagrams which together illustrate a use case for a suggestion provider which detects a condition of text positioned over a busy background (and which may therefore be more difficult to perceive) in a user's design document and generates a corresponding remediation suggestion for the text over busy background condition.

FIGS. 10A-10C are use case diagrams which together illustrate a use case for a suggestion provider which detects an opportunity to consolidate, or “unwrap”, text components that occupy multiple lines in a user's design document into a fewer number of lines and generates a corresponding remediation suggestion.

FIG. 11 an hierarchical diagram representing the problem of evaluating the quality of a given visual design.

FIG. 12 is a schematic block diagram of an exemplary system for generating design improvement suggestions.

FIG. 13 is a relational architectural diagram illustrating an example of a high-level implementation of a design suggestion tool 100.

FIG. 14 is an exemplary class diagram corresponding to the relational architectural diagram of FIG. 13.

FIG. 15 is an exemplary operational sequence diagram, illustrating one implementation of how events may be sequenced in an embodiment of the invention.

FIG. 16 is a flow diagram illustrating an exemplary embodiment of the flow of operation of the sequence illustrated in FIG. 15.

### DETAILED DESCRIPTION

Embodiments of the present invention include a computer-automated design suggestion tool which analyzes a visual design represented in an electronic document and automatically generates design improvement suggestions for the design based on the content and format of the design itself. In a preferred embodiment, one or more of the design suggestions are automatically applied to the design to generate an alternative design which incorporates the applied design suggestions. An automated design assistant may display the generated design improvement suggestions to a user. In a preferred embodiment, the generated design improvement suggestions are presented dynamically, during the creation of the design by the user and as changes are being made. In an embodiment which uses an interactive mode, the automated design assistant presents the design suggestions and includes user input controls through which a user can accept and instruct the system to automatically apply one or more of the design suggestions to the user's design.

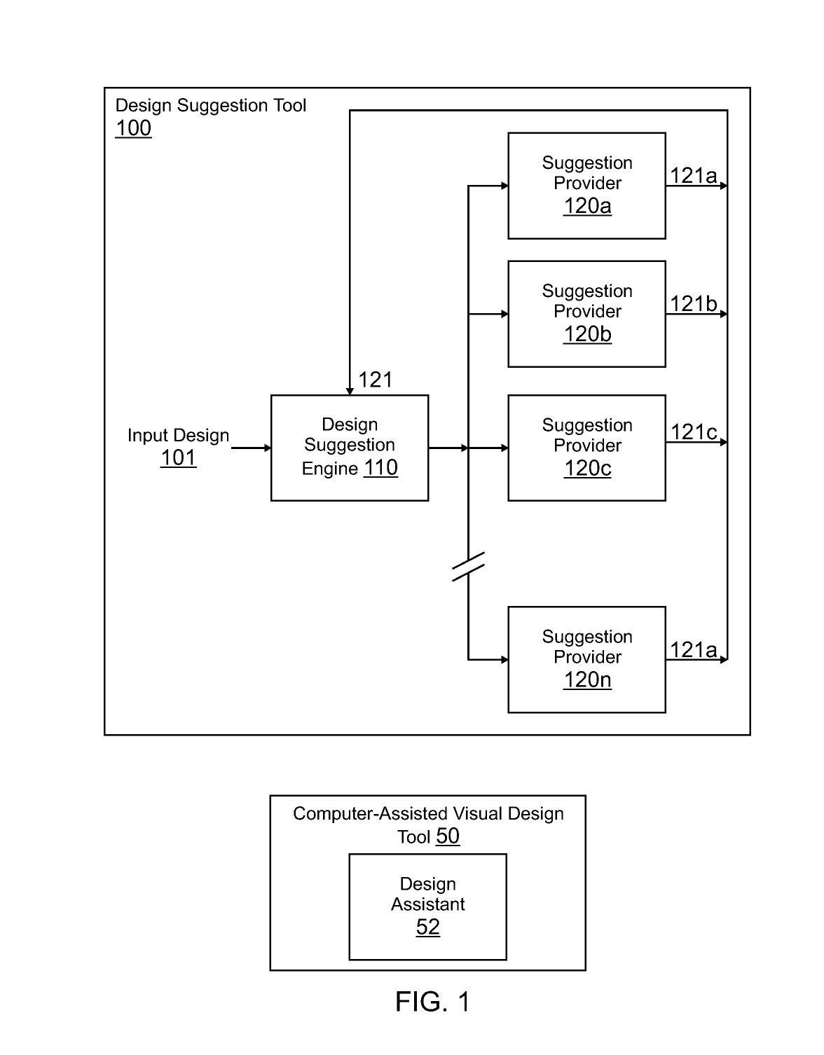

A schematic block diagram of an exemplary design suggestion tool 100 is shown in FIG. 1.

In operation, the design suggestion tool 100 receives or accesses a particular design 101. The design 101 is represented in an electronic format, such as an electronic document, an electronic file, or other electronic format in which the design is represented. For example, in an embodiment, the design is represented in a markup language such as XML, HTML, or other such markup language format.

The design suggestion tool 100 includes a suggestion engine 110 which operates as the central controller for the tool. The suggestion engine 110 invokes one or more suggestion providers 120a, 120b, . . . , 120n (referred to generically as 120). In an embodiment, the design suggestion tool 100, including the suggestion engine 110 and the suggestion providers 120, is implemented as a combination of hardware and software, and in particular as computer program instructions, which may or may not include respective independent software modules, executed by one or more computer processing units (or “processors”).

Each respective suggestion provider 120a, 120b, . . . , 120n analyzes a particular design aspect or a combination of a set of design aspects of the design 101. In general, different suggestion providers 120a, 120b, . . . , 120n independently analyze the design 101, measuring the design against different respective sets of one or more design criteria and/or design parameter(s). The criteria and/or parameter(s) against which the design 101 is measured or analyzed will typically be a validation against one or more universally-accepted good visual design principles. As part of the analysis, the suggestion provider 120a, 120b, . . . , 120n determines possible design improvements relative to the respective criteria and/or parameter(s) against which the design 101 is measured or analyzed, and if possible, generates one or more corresponding design suggestions 121a, 121b, . . . , 121n. The design suggestion may be in the form of a text description of the recommended action, and/or may be in the form of an altered version of the input design 101 having the recommended action implemented (and which may be displayed to the user).

As just described, in general, the suggestion providers 120a, 120b, . . . , 120n may each measure different aspects of the design relative to the universally-accepted good visual design principles in order to provide design improvement suggestions relative to the measured aspect of the design. For example, one suggestion provider 120a may analyze the design 101 to detect whether any text component overlaps any other text component or image component in the design 101. If text component overlap is detected, the design suggestion may be to move one or both of the text component and the component it overlaps. Continuing with this example, another suggestion provider 120b may analyze existing images included in the design 101 to extract the dominant colors of the design 101 and to compare this against the colors of the fonts used in the design 101. A design suggestion generated by such suggestion provider 120b may be a recommendation to match the font color of one or more text elements in the design to a dominant color of the design. As previously described, the design suggestion may be in the form of a text description of the recommended action (for example, recommending to or instructing the user to take the action), and/or may be in the form of an altered version of the input design 101 having the recommended action implemented.

In the embodiment shown in FIG. 1, the design suggestion tool 100 operates in conjunction with a computer-assisted visual design tool 50. In general, computer-assisted visual design tools are computer programs which execute on a processor-based electronic device having at least one computer processing unit (CPU), and present to a user a graphical user interface (GUI) on an electronic display of, or connected (either directly or remotely) to, the device. The graphical user interface typically includes a work area in which a current working version of a design is displayed, and various user-selectable tools to add, remove, edit and format content of the design displayed in the work area. The electronic device may be a traditional desktop computer, a laptop, a tablet computer, a handheld computer, a mobile “smart” phone, or any other computing device that includes, or is configured to interact with, an electronic display and user input devices.

Computer-assisted design tools exist in different operating models, including a stand-alone model, a hybrid client-server model, or a remote access (e.g., Web-access) model. In a stand-alone model, a computer-assisted visual design tool executes exclusively locally on the computing device, for example as in a typical program installed on a desktop, laptop or computing device running in an offline mode (i.e., no remote calls or interaction with remote servers). In a client-server mode, some functionality of the computer-assisted visual design tool is performed locally at the electronic device (i.e., the “client”) and some processing is performed remotely at a server (the “server”). In a remote access mode, the user's computing device operates mainly as a remote terminal device and the bulk of the computational processing occurs on a server accessed, for example, over the Internet through the World Wide Web (the “Web” or “web”). Examples of computer-assisted visual design tools include Adobe® Illustrator® and Adobe® InDesign. These tools are very powerful and used by professional graphic artists and designers. However, in order to create print-ready designs and documents, these tools require specialized training and are not easily used by the untrained layperson.

Some online retailers, such as Vistaprint.com, offer document design tools which execute in a web browser and allow a user to create a design document in a What-You-See-Is-What-You-Get (WYSISYG) environment using tools in the form of buttons, forms, widgets, and other controls. Often, the user interface will provide standard drag-and-drop functionality that is familiar to most computer users. These types of tools may be implemented and provided by an online retailer to allow users to create customized designs in electronic form (e.g., readable or interpretable by a computing device). The designs may be designed specifically for an electronic product (such as an electronic postcard, an electronic image, a web page, email, blog or social media posting, or other such product intended for electronic display), or may be incorporated on a physical product (such as in a printed document, or printed or otherwise embedded on a promotional item such as, but not limited to, a mug, t-shirt, or keychain).

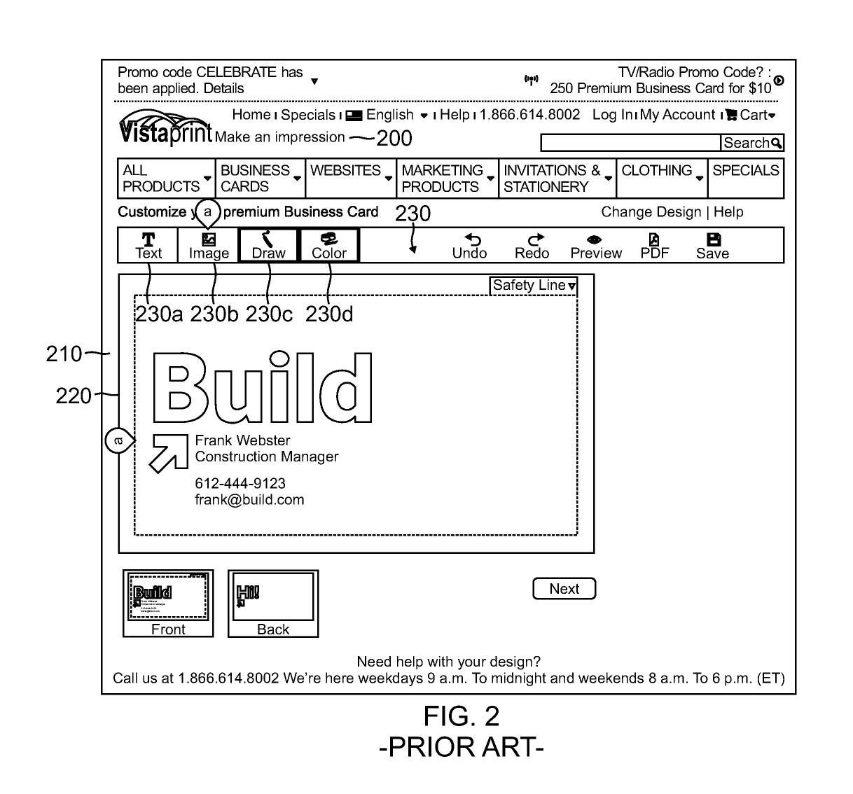

FIG. 2 illustrates an example of a user interface 200 which may be presented to a user of a traditional computer-assisted visual design tool that does not offer design suggestions to the user. As illustrated in FIG. 2, the user interface 200 includes a work area 210 in which a current working version of a user's design 220 is displayed. The user interface 200 provides tools in the form of selectable controls 230 (shown as 230a, 230b, . . . , 230i) such as buttons, icons, links, fillable form fields, etc., that, when selected by the user using a now-conventional or hereinafter-adopted selection mechanism such as a mouse click, a finger tap or slide, a keyboard stroke entry, or the like, enable a user to insert, remove, edit, position, format, or otherwise edit the format and/or content of the design 220 in the work area 210. For example, the user interface may include a control 230a for adding text to the work area 210, a control 230b for adding an image to the work area 210, a control 230c for adding a geometrical shape such as a line, a circle, a rectangle, etc. to the work area 210, a control 230d for changing a color scheme of the current design in the work area 210, etc. In an embodiment, the design 220 displayed in the work area 210 is dynamically updated as the user modifies the design using the controls 230 to make additions, deletions, edits, formats, and perform other actions which affect the visual format, appearance or presentation of the design 220. In alternative user interfaces (not shown), the design 220 displayed in the in work area 210 is updated only upon request by the user, for example by clicking a graphical “update” button (not shown) or other such control.

As will be appreciated from the above description, it is typical in current computer-assisted visual design tools to leave the user completely on their own with regard to the creation, content and layout choices of their design 210. Some computer-assisted visual design tools go a step further by providing design templates which define an initial layout and certain combinations of visual assets (such as background and foreground image(s), text components, color schemes, fonts, etc., and which may or may not include partially filled content) which may be edited by the user to customize the content and other aspects of the design. Such design tools typically allow the user to select from among a set of predefined design selections (such as images, color schemes, available fonts, graphical effects, etc.). Importantly, however, computer-assisted visual design tools are not known to attempt to assist the user in making design decisions with respect to aesthetics or with regard to whether the content of the design follows universally-accepted good visual design principles or enhances the purpose of the design. Good designs generally score highly on each of the following factors related to “universally-accepted good visual design principles”:
Degree of conformance to the designer's intent of the document
Color balance of user-supplied images relative to pre-existing images contained in the design template
Symmetry of design
Problem-free state, with respect to:
Text overlap
Text alignment
Text contrast
Text wrap
Text-over-background
Composition balance of design, with respect to:
Center of interest
Balance
Harmony
Contrast
Directional movement
Rhythm
Degree of conformance to the Rule of Thirds
Degree of conformance to the Golden ratio

For the typical layperson, creating a visual design which invokes in the viewer of the design the reaction desired by the designer, or which emanates a certain appeal, or which simply meets certain aesthetic criteria, is non-trivial. Accordingly, laypeople seeking professional-looking designs often turn to professional visual art designers, who understand and apply the universally-accepted good visual design principles (as enumerated, in part, by the factors set forth above), and who are trained to use sophisticated computer-assisted design tools, to create designs for them. While seeking out professional design services is often the correct solution in many situations, there are other situations where automated design assistance is both needed and appropriate. For example, automated design assistance may be appropriate when a professional designer is unavailable, such services are beyond the available project budget, and/or when the timeframe in which the project must be completed is too short.

In accordance with various embodiments, a computer-assisted visual design tool 50 includes a computer-automated design assistant 52 which operates in conjunction with an underlying design suggestion stool, such as the design suggestion tool 100 of FIG. 1. The design suggestion tool 100 may be incorporated into the software of the computer-assisted visual design tool 50, or may be an independent software module which executes locally on the same device as the computer-assisted visual design tool or on a remote device which is accessed remotely via the computer-assisted visual design tool 50 and/or design assistant 52.

Within the design suggestion tool 100, the design suggestion engine 110 receives or accesses a design 101, analyzes the design 101 and generates design improvement suggestions 121a, 121b, . . . , 121n specific to the analyzed design. The design assistant 52 presents one or more of the generated suggestions 121a, 121b, . . . , 121n to the user in a user interface of the computer-assisted visual design tool 50.

In an embodiment, an automated design assistant 52 offers design improvement suggestions to a user by displaying the suggestion(s) on the electronic display of, or connected to (directly or remotely), the user's device. In an embodiment, the design improvement suggestion(s) are presented during the design process—that is, while the user is in the process of creating the design using the computer-assisted visual design tool 50. The automated design assistant 52 facilitates the creation by a layperson (an unskilled professional) of professional-looking visual designs without requiring the services of a professional designer.

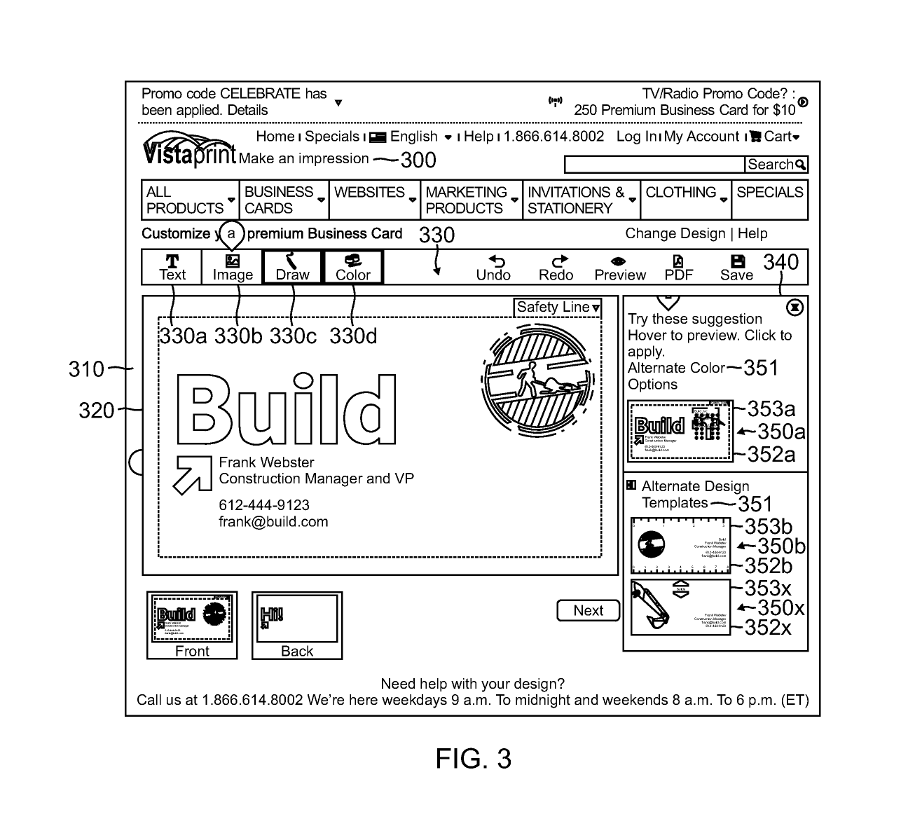

FIG. 3 illustrates an exemplary embodiment of a user interface 300 of a computer-assisted visual design tool 50 (from FIG. 1) which incorporates various embodiments of the invention. The user interface 300 includes a work area 310 and graphical user interface design controls 330a, 330b, . . . , 330d, similar in operation to the corresponding work area 210 and controls 230a, 230b, . . . , 230d of FIG. 2. In addition, the graphical user interface 300 includes a suggestion panel 340. The suggestion panel 340 may provide one or more design suggestions 350 (shown as 350a, 350b, . . . , 350x). The design suggestions 350 may be in the form of instructional text 351 (shown individually as 351a, 351b, . . . 351x) suggesting to a user specific changes to make in order to potentially improve the current version of the design 320. In a preferred embodiment, any given suggestion 350 may include an image 352 (shown individually as 351a, 351b, . . . 351x) of an alternative version of the design illustrating how the design 320 would look if the respective suggestion is implemented and applied to the design 320. In such preferred embodiment, the suggestion 350 includes a user-selectable control 353 which, upon activation by user input (such as one or more mouse clicks or finger taps), automatically applies the proposed suggestion 350 to the design 320 and updates the work area 310 to display the updated design 320.

The marriage of the computer-assisted visual design tool 50 with the design suggestion tool 100 via the user interface 300 provides an effective automated technological framework and automated professional designer assistant (in the form of the suggestion panel 340) to aid the layperson user in producing more professional visual designs that are aligned with the intent of the designer, using elements from the universally-accepted principles of good visual art design, similarly to what a professional designer can do intuitively.

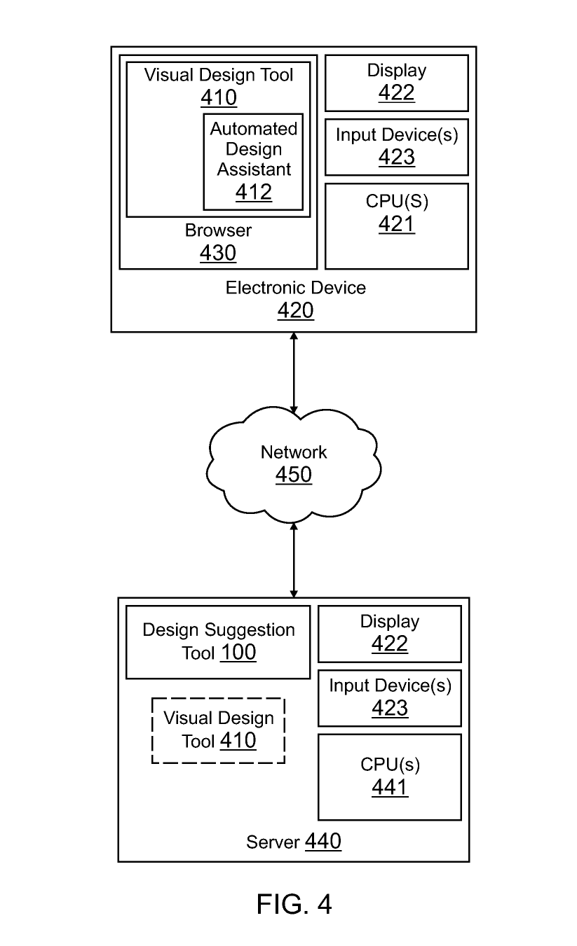

FIG. 4 is a schematic block diagram of an exemplary environment 400 in which embodiments of the invention may operate. The environment 400 includes at least one electronic device 420 configured with one or more computer processing units 421 for executing program instructions. The electronic device 420 can be a personal computer such as a desktop or tower computer, a portable device such as a laptop computer, a tablet or handheld device, a cellular phone equipped with a display screen and data access (such as a smartphone), a shared computing system comprising one or more servers and servicing one or more users (which may be, for example only and not limitation, accessed over the Internet), or any device configured with one or more processing units (such as a computer processing unit (CPU), microprocessor, ASIC, or other hardware processor) 421, one or more electronic display screen(s) 422, and one or more user input device(s) 423 (such as a keyboard, a mouse, a touch screen, etc.).

The environment 400 further includes a computer-assisted visual design tool 410, such as 50 in FIG. 1. In an embodiment, the visual design tool 410 is a software module executed by the processing unit(s) 421 on the user's electronic device 420. In an exemplary embodiment, the visual design tool 410 may be downloaded from a server 440 over a network 450 (for example, over the Internet) and executes within a Web browser 430 executing on the user's electronic device 420. Alternatively, the visual design tool 410 is a program or application that resides on the device 420 and executes without the need for a Web browser. In yet another alternative, the visual design tool 410 executes entirely on a server 440 and is accessed from a user's electronic device 420 via a Web browser 430 running on the user's device 420.

The computer-assisted visual design tool 410 provides a graphical user interface (GUI), such as 300 shown in FIG. 3, that is displayed on the display 422, and which allows a user to create and edit a design via input device(s) 423. Executing within or in cooperation with the visual design tool 410 is an automated design assistant module 412 which provides the functionality for the design assistant 52 (see FIG. 1). The automated design assistant module 412 provides an interface between the visual design tool 410 and a design suggestion tool 100 (FIGS. 1 and 4). Preferably, the automated design assistant module 412 is integrated into the computer program code of, or is called from, the visual design tool 410.

The automated design assistant module 412 may request the design suggestion tool 100 to generate suggestions for a design 320, and may supply the current version of the design 320 or a link or other reference thereto to the design suggestion engine 100. The automated design assistant module 412 may update the content displayed in the suggestion panel 340 in the user interface 300 (see FIG. 3) to display and inform the user about design suggestions generated by the design suggestion engine 100. Additionally, the automated design assistant 412 may be configured to monitor user input for requests to apply one or more suggestions to the design 320, and instructs the visual design tool 410 to apply design suggestions when instructed to do so via user input.

In an embodiment, the design suggestion tool 100 resides on a server 440, and the automated design assistant module 412 resides on the user's electronic device 420. The automated design assistant module 412 executing on the user's electronic device 410 operates as the interface to coordinate sending to the design suggestion tool 100 the design input necessary to analyze and generate design suggestions 121 (see FIG. 1), and to coordinate receiving and displaying the suggestions 121 (also 350a, 350b, 350x in the suggestion panel 340 in FIG. 3) as generated by the design suggestion tool 100. In alternative embodiment(s) (not shown), the design suggestion tool 100 itself may be executed on the user's electronic device 420. In such alternative embodiment(s), the design suggestion tool 100 is part of a stand-alone application running on the user's electronic device 420. Alternatively, the design suggestion engine 100 is downloaded from the server 440 to the device 410 upon initiation of the visual design tool 410, or may be installed as a plugin at any time prior to its use.

With reference to FIG. 1, the design suggestion tool 100 receives a user's design 101 (or 320 in FIG. 3) and submits the design to a plurality of different design suggestion providers 120a-120n for analysis. Each different suggestion provider 120a, 120b, . . . ,120n analyzes the submitted design 101 against a set of predefined criteria and/or parameters. In particular, each suggestion provider 120a, 120b, . . . ,120n processes the submitted design 101 using a respective predefined process or algorithm, to generate, if determined to be appropriate, one or more suggestions 121 (shown individually as 121a, 121b, 121c, . . . , 121n). Each suggestion 121a, 121b, 121c, . . . , 121n is generated in accordance with the programmed algorithm specific to the respective suggestion provider 120a, 120b, . . . ,12. In an embodiment, the design suggestion tool 100 ranks the suggestions 121 generated by the plurality of suggestion providers 120. When multiple suggestions are generated, the automated design assistant module 412 preferably displays only the top-ranked suggestions 121 in the suggestion panel 340 (see FIG. 3).

In an embodiment, the respective suggestion providers 120a, 120b, . . . ,120n are configured to generate a respective modified version 122 (referred to individually as 122a, 122b, 122c, . . . , 122n) of the particular design 101 under analysis. Specifically, each respective modified version 122a, 122b, 122c, . . . , 122n of the design 101 may be automatically modified, under control of the respective suggestion provider 120a, 120b, 120c, . . . , 120n, to apply to the design 101 the suggestion(s) 121a, 121b, 121c, . . . , 121n of the respective suggestion provider. In an embodiment, an image 352 (e.g., 352a, 352b, . . . , 352x) of the respective modified version 122 of the design 101 is displayed in the suggestion panel 340 when the suggestion 122 is presented to the user by the automated design assistant 412. The modified design image 352a, 352b, . . . , 352x may be a thumbnail image (i.e., a lower-resolution image of the full-resolution image of the design) in order to increase speed of the tool 400, but may also be a higher-resolution image if suitable for the size of the display 422. A respective selection control 353 (shown as 353a, 353b, . . . 353x) associated with each respective suggestion 350 (shown as 350a, 350b, . . . 350x) monitors for user selection of the respective control 353 and upon selection by the user of the particular control 353 operates to effect replacement of the design 320 (also 101 in FIG. 1) displayed in the work area 310 of the graphical user interface 300 of FIG. 3 with the modified version of the design as represented in the image 352a, 352b, . . . , 352x associated with the particular selected suggestion selection control 353a, 353b, . . . 353x. The replacement design 320 becomes the new current version of the user's design. In an embodiment, the replaced design may be saved and a control may be provided (not shown) to allow the user to undo the replacement to return to the original design. Additionally, the graphical user interface could be provisioned to save the history of the designs and to allow a user to return to a design earlier in the history if desired.

FIG. 1 shows an embodiment in which the design suggestion engine 110 submits the original design to various ones of the suggestion providers 120 and receives back suggestions 121 from the suggestion providers 120. In a simple implementation, the design suggestion engine 110 could present the received suggestions (and optionally rank them) and be done. More sophisticated embodiments could, however, chain the design output of various ones of the suggestion providers 120 to the design input of others of the suggestion providers 120 in order to apply multiple design suggestions to the design, if need be, prior to ranking and presenting the suggestions to the user. Before presenting a more detailed discussion of the nuances and benefits of forming chains of suggestion providers, a discussion of the types of suggestions is helpful.

In general, the visual design improvement suggestions 121 generated by the various suggestion providers 120 each belong to one of three categories: (1) design validation, (2) design short-cuts, and (3) aesthetic recommendations.

Design validation: suggestions of this type deal with detected design rule violations where it is difficult to determine user error from user intent. In general, a design validation suggestion provider is configured to analyze a design against one or more specific design rules and to detect violations of any of these specific rule(s). In these cases, the suggestion provider may be configured to further generate as at least part of the output an alternate version of the design that “corrects” the rule violation(s). In such case, when the suggestion is offered to the user, an image of the alternate version of the design may be displayed to the user via the automated design assistant (for example, displayed in suggestion panel 340 of FIG. 3). The user can accept or ignore the suggestion by actively selecting the selection control 353 associated with the suggestion 350 in the suggestion panel 340. In the example user interface of FIG. 3, the user accepts a displayed suggestion 350 by clicking on the associated image 352. In an embodiment, the control 353 operates to show or animate the proposed change in the design 320 displayed in the work area 310 of the GUI 300. An example of a design validation suggestion is where a text overlap suggestion provider detects a text element overlapping an image element. While generally it may be undesirable to have a text component overlap an image component in a design, in some cases a user may specifically intend for the text component to overlap the image component. Accordingly, these types of rule violations are inherently “fuzzy” errors since it is not necessarily possible for the suggestion provider to know when the suggestion is correct without user input.

Short-cuts: suggestions of this type deal with attempting to automate certain repetitive tasks performed by the user. In these cases the suggestion engine divines user intent from user input and user behavior (either the behavior of the particular user using the tool, or the behavior of other users using the tool in other sessions, or both), and recommends time saving alternatives. An example of a short-cut suggestion is the auto-filling of text components with user information derived from the user's previous input. Another example of a short-cut suggestion is the detection of clusters of similar design components and, when a user applies a change to one component in the cluster, suggesting the same change to the remaining design components in the same cluster.

Aesthetic recommendations: the suggestion engine operating on a set of assumptions can recommend alternative designs that subscribe to best practices that have been encoded as an algorithm—for example, applying k-means for color suggestions, or applying Phi for partial upload aspect ratios. An example of an aesthetic recommendation suggestion is an alternative version of a design having font color changed to a dominant color in the design image(s).

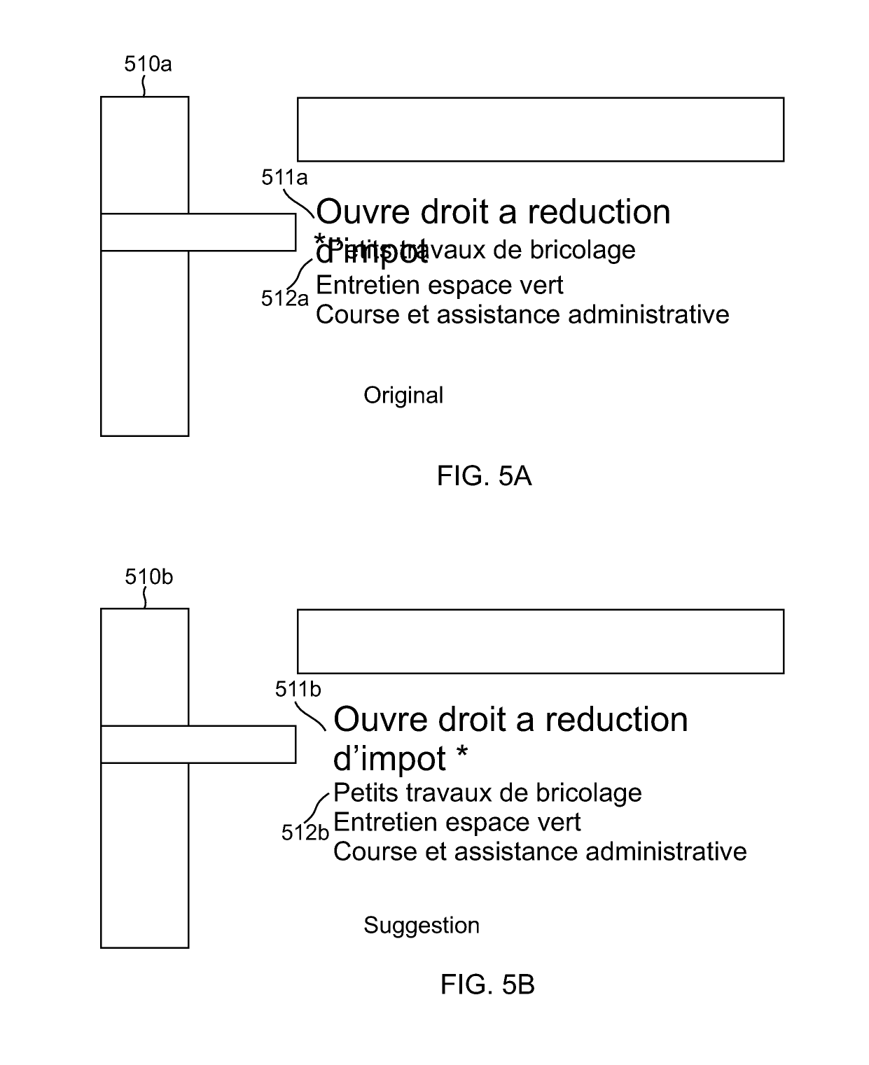

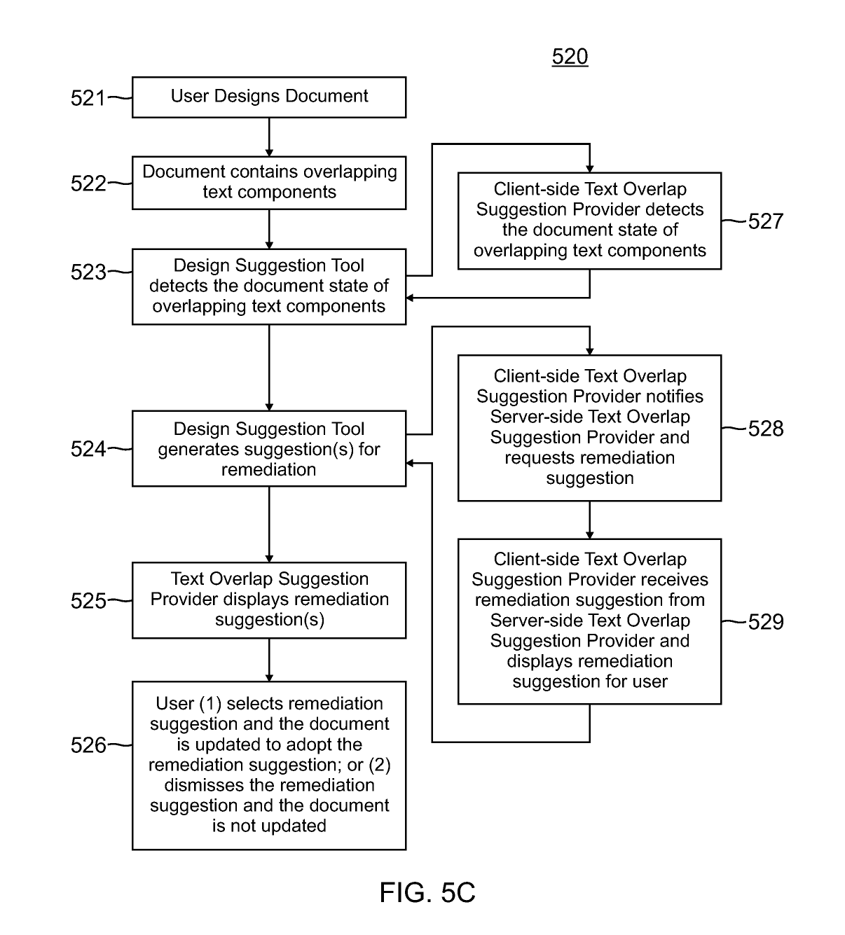

FIGS. 5A-5C, through 10A-10C illustrate various examples of original designs, and corresponding design improvement suggestions generated by different suggestion providers 120 in a design suggestion tool 100, and corresponding operational flow charts of different suggestion providers 120, to illustrate examples of different types of suggestion providers 120 that could be implemented in the design suggestion tool 100.

FIGS. 5A-5C illustrate a use case for a suggestion provider which detects a text overlap condition in a user's design document and generates a corresponding remediation suggestion for the text overlap condition. FIG. 5A illustrates an original design 510a that includes a first text component 521a overlapping a second text component 522a. A suggestion provider 520 may be configured to detect text overlaps and to generate a suggestion in the form of a version of the original design in which text components do not overlap one another. FIG. 5B illustrates an example suggested design in which one or both of the first and second text components 521b and 522b have been repositioned so that they do not overlap.

FIG. 5C shows a flow diagram illustrating a use case for a suggestion provider 520 which is configured to detect a text overlap condition and provide a suggestion which remediates the text overlap condition. As illustrated, a user creates a visual design in the form of a document (step 521). During creation of the document, one or more of the text components in the design overlaps another of the text components (step 522). A design suggestion tool detects the state of overlapping text components in the document (step 523). The design suggestion tool generates one or more suggestion(s) for remediating the overlapping text condition (step 524). The design suggestion tool displays the remediation suggestion(s) (step 525). The user either (1) selects a remediation suggestion via a selection control provided in connection with the displayed remediation suggestion, or (2) dismisses or ignores the remediation suggestion (step 526). When the user selects a remediation suggestion, the document is updated to implement the selected remediation suggestion; otherwise, the document is not updated.

In an embodiment, the design suggestion tool 100 includes a client-side text overlap suggestion provider which executes on the user's electronic device (i.e., the client device) and a server-side text overlap suggestion provider which executes on a remote server (i.e., the server device). In a preferred embodiment, the client-side text overlap suggestion provider performs the condition detection—that is, the client-side text overlap suggestion provider analyzes the current state of the document and determines whether a text overlap condition is present (step 527). In such an embodiment, when the client-side text overlap suggestion provider detects a text overlap condition, the client-side text overlap suggestion provider notifies the server-side text overlap suggestion provider and requests a suggestion which remediates the condition (step 528). The server-side text overlap suggestion provider generates a suggestion for remediating the text overlap condition. In a preferred embodiment, the server-side text overlap suggestion provider analyzes the current document and repositions, in a modified version of the user's document, one or more text components in the document design so that the text components in document do not overlap. In a preferred embodiment, the modified version of the user's document is saved at the server and a thumbnail image of the document design is generated for use in displaying the modified version of the user's document in the suggestion panel 340 of the graphical user interface 300. The client-side text overlap suggestion provider receives the remediation suggestion from the server-side text overlap suggestion provider and displays the suggestion (step 529). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

In an embodiment, the text overlap suggestion provider may be implemented to perform a tree-graph algorithm, which conceptually views a design as a tree graph. The tree graph algorithm traverses the tree graph of a design inspecting text component nodes resolving overlap node conflicts discovered. Below is an exemplary embodiment of how the tree graph algorithm operates:

Text Overlap - Tree Graph Algorithm Pseudo-code:

```
Given a design, model the design component in a tree graph representation
  Loop through all text nodes top to bottom
    if text node is off canvas, ignore
    if text node is monogram, ignore
    get list of overlapping text nodes
      Loop through all overlapping text nodes
          if text node is monogram, ignore
          if text node is shadow, ignore
          if overlapping node is child of current node, shift overlapping
node down to resolve overlap
          else if overlapping node is parent of current node, shift
overlapping node up to resolve overlap
          else if overlapping node's left is further right than current
node, shift overlapping node right to resolve overlap
          else if overlapping node's left is further left than current
node, shift overlapping node left to resolve overlap
      End Loop
  End Loop
```

In an alternative exemplary embodiment, the text overlap suggestion provider may be implemented to perform a column-graph algorithm. The column-graph algorithm can resolve text overlap problems effectively for designs that have text components arranged in columns. The column-graph algorithm may be less robust than the tree graph version because not all designs can be modeled as columns; however, the column-graph algorithm can sometimes perform better for column-based designs since it conceptually views the design similarly to what a human would see for this specific case.

Text Overlap - Column Graph Algorithm Pseudo-code:

```
Given a design, model the design as a column graph
  Loop through all columns in design
    Loop through each column item in each column
      Loop through all resolution strategies
        Safety-Margin X-axis resolution strategy
          if item has safety margin problem
            get distance of item from left and right safe margins
            pick the minimum distance to move item to resolve problem
            move item to the new position to resolve overlap
          end if
        Safety-Margin Y-axis resolution strategy
          if item has safety margin problem
            if item is outside safety margin on the top, shift down into
            safe area
            else shift up into safe area
          end if
        Overlapping item on X-axis resolution strategy
          if there is another column adjacent to current column
            shift the other column with the overlapping text right
          end if
        Overlapping item on Y-axis resolution strategy
          if item is a shadow of item it is overlapping, ignore.
          if item is overlapping previous item in column
            shift down to resolve overlap
          end if
      End Loop
    End Loop
  End Loop
```

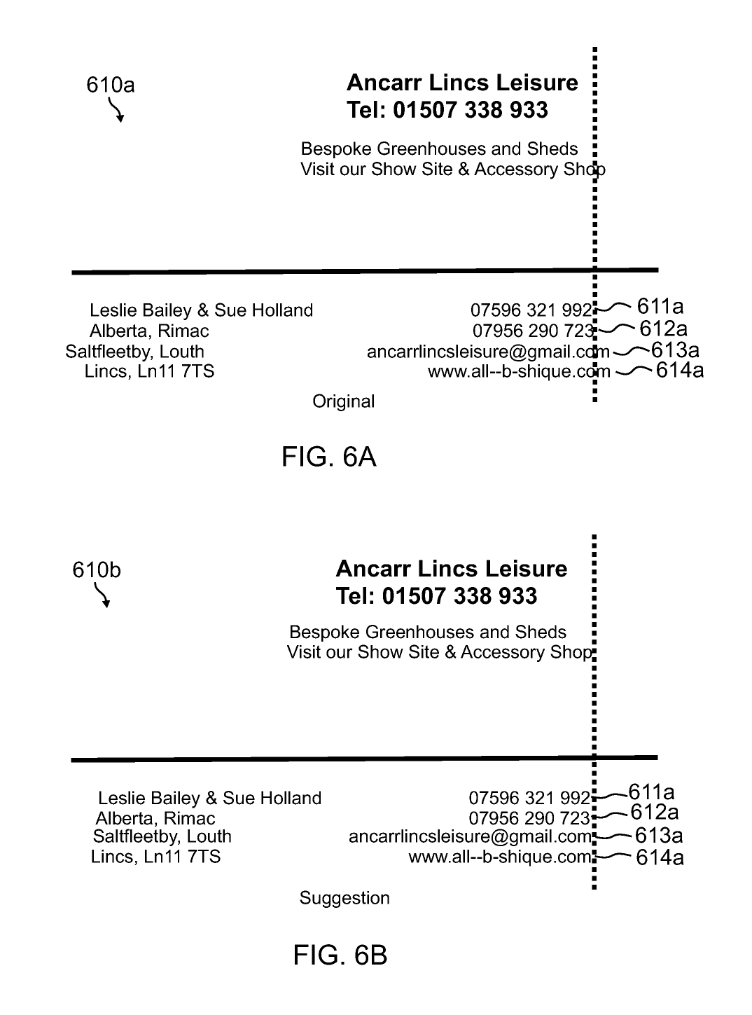

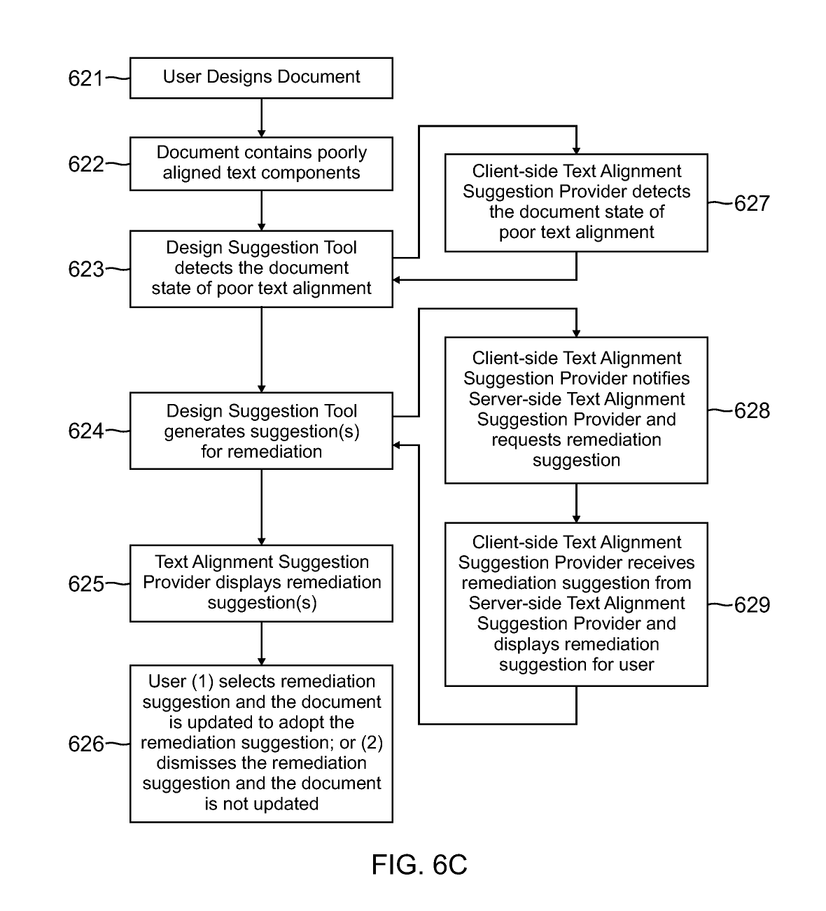

FIGS. 6A-6C illustrate a use case for a suggestion provider which detects a poor text alignment condition in a user's design document and generates a corresponding remediation suggestion for the poor text alignment condition. FIG. 6A illustrates an original design 610a that includes multiple text components 621a, 622a, 613a, 614a which appear to be arranged in a column. Text components 621a and 622a are right-edge aligned along a first edge, and text components 613a and 614a are right-edge aligned along a second edge. However, since the first edge is different than the second edge, the column does not look quite right. A better design may be to align the right edges of all four stacked components 621a, 622a, 613a, 614a, to the same right edge. A suggestion provider 620 may be configured to detect text mis-alignment conditions and to generate a suggestion in the form of a version of the original design in which text mis-alignment conditions are corrected such that text components which should be aligned along a same edge (left, right, or middle) are in fact aligned to a common edge. FIG. 6B illustrates an example suggested design 610b in which all of the text components 621a, 622a, 613a, 614a in the identified column are aligned to the same right edge.

FIG. 6C shows a flow diagram illustrating a use case for a suggestion provider which is configured to detect a condition of poor text alignment and provide a suggestion which remediates the poor text alignment condition. As illustrated, a user creates a visual design in the form of a document (step 621). During creation of the document, a plurality of text components are poorly aligned (step 622). A design suggestion tool detects state of poor text alignment in the document (step 623). The design suggestion tool generates one or more suggestion(s) for remediating the poor text alignment condition (step 624). The design suggestion tool displays the remediation suggestion(s) (step 625). The user either (1) selects a remediation suggestion via a selection control provided in connection with the displayed remediation suggestion, or (2) dismisses or ignores the remediation suggestion (step 626). When the user selects a remediation suggestion, the document is updated to implement the selected remediation suggestion; otherwise, the document is not updated.

In an embodiment, the design suggestion tool 100 includes a client-side text alignment suggestion provider which executes on the user's electronic device (i.e., the client device) and a server-side text alignment suggestion provider which executes on a remote server (i.e., the server device). In a preferred embodiment, the client-side text alignment suggestion provider performs the condition detection—that is, the client-side text alignment suggestion provider analyzes the current state of the document and determines whether a poor text alignment condition is present (step 627). In this embodiment, when the client-side text alignment suggestion provider detects a poor text alignment condition, the client-side text alignment suggestion provider notifies the server-side text alignment suggestion provider and requests a suggestion which remediates the condition (step 628). The server-side text alignment suggestion provider generates a suggestion for remediating the poor text alignment condition. In a preferred embodiment, the server-side text alignment suggestion provider analyzes the current document and repositions, in a modified version of the user's document, one or more text and/or graphical components of the document design to align the poorly aligned text components. In a preferred embodiment, the modified version of the user's document is saved at the server and a thumbnail image of the document design is generated for use in displaying the modified version of the user's document in the suggestion panel 340 of the graphical user interface 300. The client-side text alignment suggestion provider receives the remediation suggestion from the server-side text alignment suggestion provider and displays the suggestion (step 629). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

In an embodiment, the text alignment suggestion provider may be implemented to perform an algorithm which conceptually creates logical groupings of the text components in the document based on spatial distance between fields, and then determines whether the text components in each logical grouping are aligned. Below is pseudo-code illustrating an exemplary embodiment of a text alignment algorithm:

Text Alignment - Pseudo code:

```
Given a design graph
  Create logical groupings for text components based on spatial
  distance between fields
  Loop through all text groupings
    if all fields in text group are aligned, ignore
    else normalize text components and figure out candidates worth
    fixing
    Loop fix candidates
      if text node is off canvas, ignore
      if text node is monogram, ignore
      if text node is shadow, ignore
      fix alignment by moving text component
    End Loop
  End Loop
```

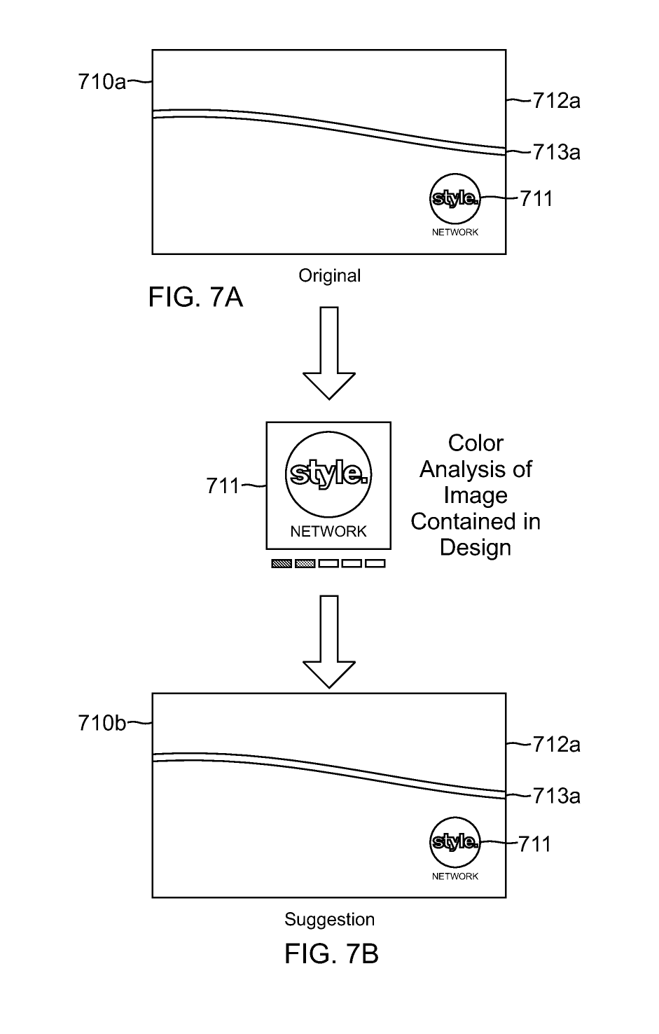

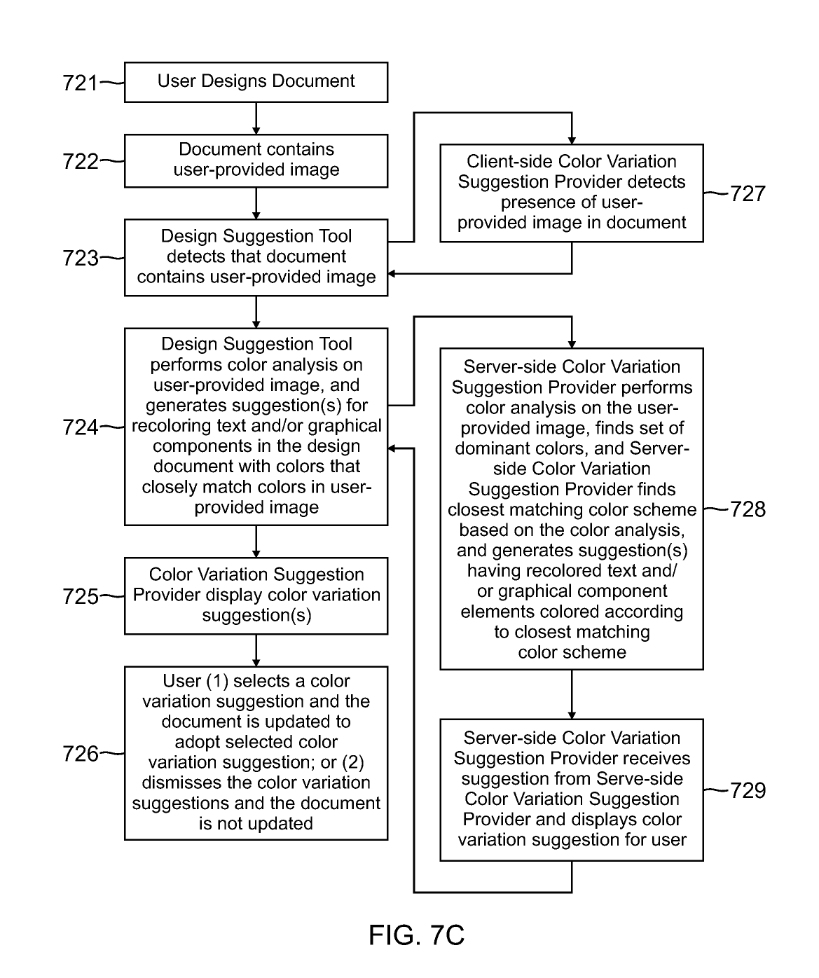

FIGS. 7A-7C illustrate a use case for a suggestion provider which provides a suggestion for implementing a color variation for a user's design. FIG. 7A illustrates an original design 710a that includes multiple graphical components 722a, 713a and an image component 711. The color variation suggestion provider may be configured to identify an image component 711 in the original design 710a, analyze the colors of the image component 711, and generate a variation of the design document 710b based on a color variation algorithm for recoloring various graphical components 722b, 713b to generate a color variation 710b of the original design 710a. The variation design document 710b may be presented as a color variation suggestion by a Color Variation suggestion provider.

FIG. 7C shows a flow diagram illustrating a use case for a suggestion provider which is configured to generate a color variation of the current user design. As illustrated, a user creates a visual design in the form of a document (step 721). During creation of the document, the user inserts an image into the document (step 722). The image is provided by the user. The user-provided image is provided by the user by selecting an image and inserting the selected image into the document. The selected image may be selected from the user's own image collection (for example, user's electronic photograph files), or may be selected by the user from a database of images. The database from which the user selects the image, and/or the images contained therein, may be owned by the user, or alternatively may be owned by a different party (i.e., individual or company). The selected image may be an image that is stored locally at the user's electronic device; alternatively, the selected image may be stored on a remote electronic device and uploaded from the remote device to be inserted into the document.

A design suggestion tool detects the presence of a user-provided image in the document (step 723). The design suggestion tool performs color analysis on the user-provided image, and generates one or more suggestion(s) for recoloring text and/or graphical components in the design with colors that closely match one or more colors contained in the user-provided image (step 724). In an embodiment, the color(s) selected to recolor one or more text and/or graphical elements comprises at least one dominant color in the user-provided image. The design suggestion tool displays the color variation suggestion(s) (step 725). The user either (1) selects a color variation suggestion via a selection control provided in connection with the displayed remediation suggestion, or (2) dismisses or ignores the color variation suggestion (step 726). When the user selects a color variation suggestion, the document is updated to implement the selected color variation suggestion; otherwise, the document is not updated.

In an embodiment, the design suggestion tool 100 includes a client-side color variation suggestion provider which executes on the user's electronic device (i.e., the client device) and a server-side color variation suggestion provider which executes on a remote server (i.e., the server device). In a preferred embodiment, the client-side color variation suggestion provider performs the condition detection—that is, the client-side color variation suggestion provider analyzes the current state of the document and detects the presence (or non-presence) of a user-provided image in the document (step 727). In this embodiment, when the client-side color variation suggestion provider detects the presence of a user-provided image in the document, the client-side color variation suggestion provider notifies the server-side color variation suggestion provider and requests a suggestion. The server-side color variation suggestion provider generates a color variation suggestion based on the colors (preferably dominant) contained in the user-provided image (step 728). In a preferred embodiment, the server-side color variation suggestion provider analyzes the colors of the user-provided image, and recolors, in a modified version of the user's document, one or more text and/or graphical components of the document design to substantially match at least one color contained in the user-provided image. In a preferred embodiment, the text and/or graphical components in the design represented by the document are styled according to a color scheme—that is, groups of text and/or graphical elements may be assigned different respective colors according to a defined color scheme. An entire design can be recolored easily using color schemes: by predefining a number of different color schemes, each specifying a particular different color for each of the text and/or graphical element groups, the colors assigned to the design and to each text and/or graphical element in each corresponding group of the design, can be changed instantly by pointing to a different predefined color scheme. Color schemes are commonly set up in markup language document such as HTML and other browser-interpretable documents using Cascading Style Sheets (CSS), which are commonly used to separate the appearance and formatting of a document from the substantive content of a document. In a preferred embodiment, the modified version of the user's document is saved at the server and a thumbnail image of the document design is generated for use in displaying the modified version of the user's document in the suggestion panel 340 of the graphical user interface 300. The client-side color variation suggestion provider receives the color variation suggestion from the server-side color variation suggestion provider and displays the suggestion (step 729). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

In an embodiment, the text alignment suggestion provider may be implemented to perform an algorithm which conceptually creates logical groupings of the text components in the document based on spatial distance between fields, and then determines whether the text components in each logical grouping are aligned. Below is pseudo-code illustrating an exemplary embodiment of a color variation algorithm which a color variation suggestion provider may implement:

Color Variation - Pseudo-Code:

```
Given a design containing an image:
  Region[ ] recolorableRegions = GetRecolorableRegions(design)
  Color[ ] dominantUploadColors = GetDominantColors(design.Upload)
  Bitmap recoloredOutput
  Loop through each region in recolorableRegions
    Loop through each color in dominantUploadColors
      perform heuristics to identify color-region matches
      if color is the best match for region
        determine the hue, value, and saturation offsets required to
        re-color this region
        draw the re-colored region to recoloredOutput
        break
      end if
    End loop
  End loop
return recoloredOutput
```

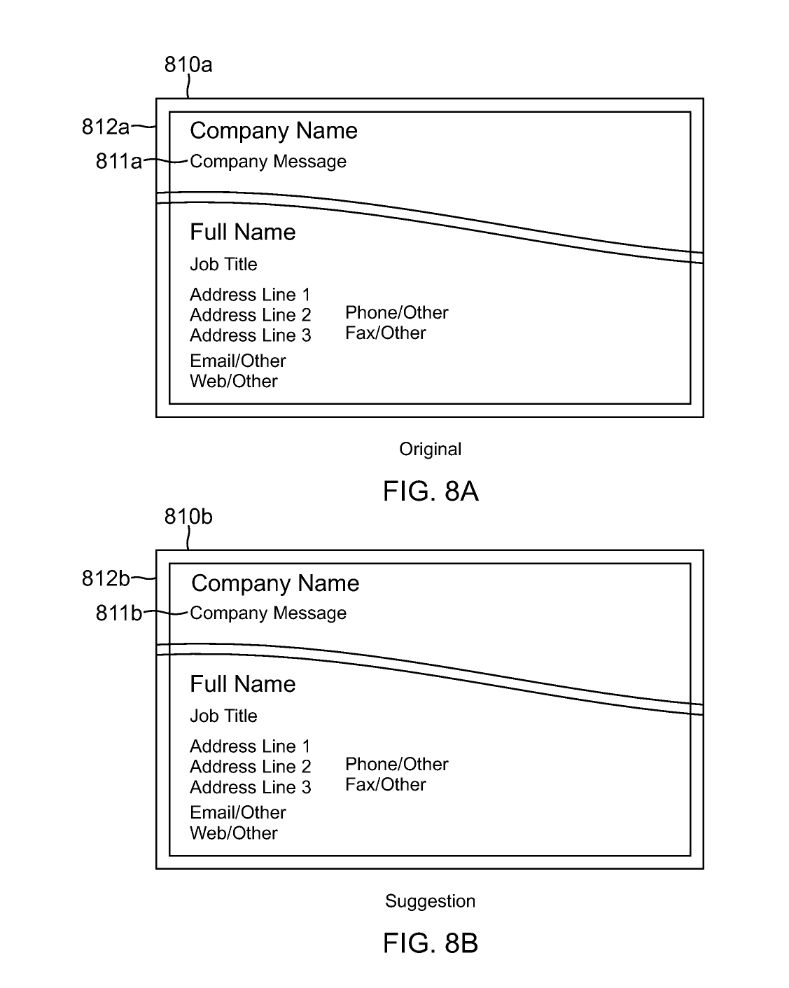

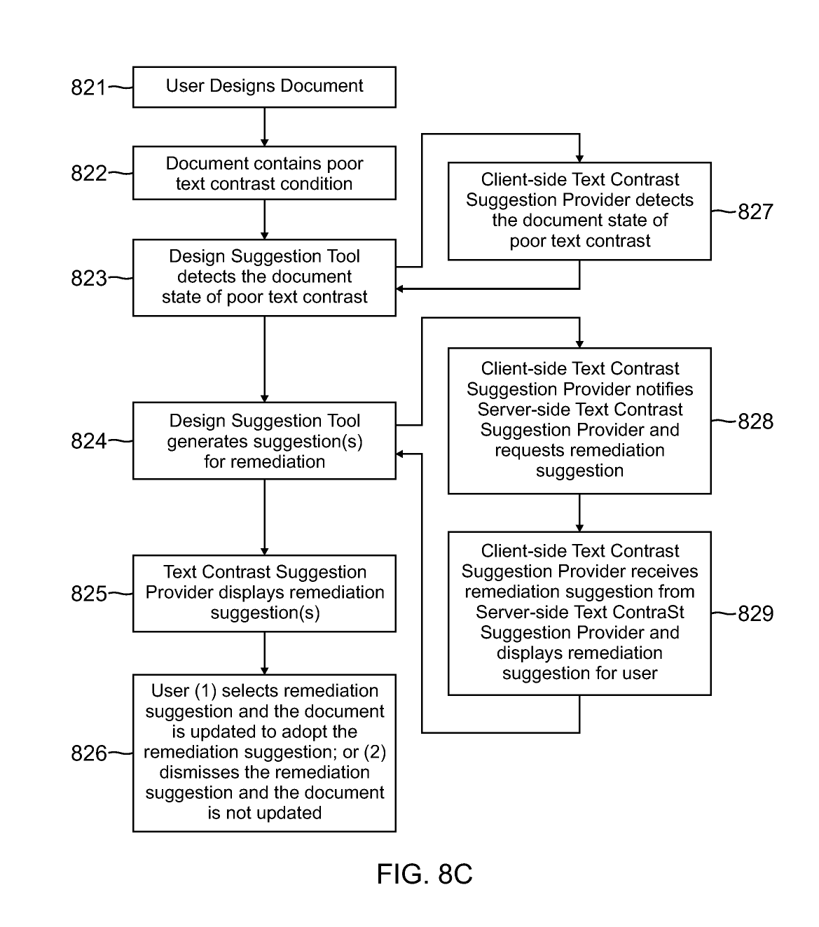

FIGS. 8A-8C illustrate a use case for a suggestion provider which detects a poor text contrast condition in a user's design document and generates a corresponding remediation suggestion for the poor text contrast condition. FIG. 8A illustrates an original design 810a that includes a text component 821a that overlaps a low-contrast background 822a. Text component 821a is configured in a first color. The first color does not contrast well against the color of the graphical component 822a which appears as background to the text component 821a. Due to the poor contrast, it is difficult to read the text component 821a. A better design may be to color the text component 821a using a second color that contrasts better against the color of the background graphical component 822a. A suggestion provider 120 may be configured to detect poor text contrast conditions and to generate a suggestion in the form of a version of the original design in which text contrast conditions are corrected. FIG. 8B further illustrates an example suggested design in which the text components 821b (which corresponds to text component 821a from the original design 810a) has been recolored to a color characterized by high contrast against the background graphical component 822b (which corresponds to text component 822a from the original design 810a).

FIG. 8C shows a flow diagram illustrating a use case for a suggestion provider which is configured to detect a condition of poor text contrast and provide a suggestion which remediates the poor text contrast condition. As illustrated, a user creates a visual design in the form of a document (step 841). During creation of the document, a text component has poor contrast against its background (step 842). A design suggestion tool detects state of poor text contrast in the document (step 843). The design suggestion tool generates one or more suggestion(s) for remediating the poor text contrast condition (step 844). The design suggestion tool displays the remediation suggestion(s) (step 845). The user either (1) selects a remediation suggestion via a selection control provided in connection with the displayed remediation suggestion, or (2) dismisses or ignores the remediation suggestion (step 846). When the user selects a remediation suggestion, the document is updated to implement the selected remediation suggestion; otherwise, the document is not updated.

In an embodiment, the design suggestion tool 100 includes a client-side text contrast suggestion provider which executes on the user's electronic device (i.e., the client device) and a server-side text contrast suggestion provider which executes on a remote server (i.e., the server device). In a preferred embodiment, the client-side text contrast suggestion provider performs the condition detection—that is, the client-side text contrast suggestion provider analyzes the current state of the document and determines whether a poor text contrast condition is present (step 847). In this embodiment, when the client-side text contrast suggestion provider detects a poor text contrast condition, the client-side text contrast suggestion provider notifies the server-side text contrast suggestion provider and requests a suggestion which remediates the condition (step 848). The server-side text contrast suggestion provider generates a suggestion for remediating the poor text contrast condition. In a preferred embodiment, the server-side text contrast suggestion provider analyzes the current document and repositions, in a modified version of the user's document, one or more text and/or graphical components of the document design to determine and select a text color with high contrast relative the background color over which the text component is positioned. In a preferred embodiment, the modified version of the user's document is saved at the server and a thumbnail image of the document design is generated for use in displaying the modified version of the user's document in the suggestion panel 340 of the graphical user interface 300. The client-side text contrast suggestion provider receives the remediation suggestion from the server-side text contrast suggestion provider and displays the suggestion (step 849). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

Below is pseudo-code illustrating an exemplary embodiment of a text contrast algorithm:

Text Contrast - Pseudo-Code:

```
Given a design graph
  Loop through all text nodes top to bottom, left to right
    if text node is off canvas, ignore
    if text node has a shadow, ignore
    if text node has a poor text contrast problem
      loop through prioritized list of resolution strategies to find first
strategy that resolves problem
        if strategy resolves problem
          done!
      end if
  Strategies:
  TEST_ALL_FIELD_COLORS:
    loop through all field colors detected in design
      if changing color of field to color resolves
        done!
      end if
    end loop
  TEST_ALL_COLORS_IN_DESIGN:
    loop through all colors detected in design including imagery
      if changing color of field to color resolves
        done!
      end if
    end loop
  TEST_MOVING_TEXT_TOP_TO_BOTTOM:
    determine minimum displacement distance of text node from top,
  and bottom a single pixel at a time test moving text node in direction
  of top or bottom based on minimum displacement distance
    if move resolves issue
      done!
    end if
  end loop
  end if
  End Loop
```

Resolution of poor contrast depends on calculating the contrast between the text component 821a and background component 822a. In a preferred embodiment, the contrast is detected based on the Red, Green, Blue (RGB) values of the pixels of the image corresponding to the text and background components in the design. In one embodiment, the contrast can be calculated using relative luminance calculations and contrast ratio calculations as defined in the Web Content Accessibility Guidelines (WCAG) 2.0 from W3C. Almost all systems used today to view Web content assume Standard RGM (sRGB) encoding. In sRGB colorspace, relative luminance is defined as the relative brightness of any point in a colorspace, normalized to 0 for darkest black and 1 for lightest white. For the sRGB colorspace, the relative luminance of a color is defined as

L=0.2126*R+0.7152*G+0.0722*B

where R, G and B are defined as:
if R_{sRGB}<=0.03928 then R=R_{sRGB}/12.92 else R=((R_{sRGB}+0.055)/1.055)^{2.4}
if G_{sRGB}<=0.03928 then G=G_{sRGB}/12.92 else G=((G_{sRGB}+0.055)/1.055)^{2.4}
if B_{sRGB}<=0.03928 then B=B_{sRGB}/12.92 else B=((B_{sRGB}+0.055)/1.055)^{2.4}

and R_{sRGB}, G_{sRGB}, and B_{sRGB} are defined as:
R_{sRGB}=R_{8bit}/255
G_{sRGB}=G_{8bit}/255
B_{sRGB}=B_{8bit}/255

The contrast ratio is defined as
(L1+0.05)/(L2+0.05), where
L1 is the relative luminance of the lighter of the colors, and
L2 is the relative luminance of the darker of the colors.

In an embodiment, contrast is measured with respect to the specified background over which the text is rendered in normal usage. If no background color is specified, then white is assumed. Background color is the specified color of content over which the text is to be rendered in normal usage.

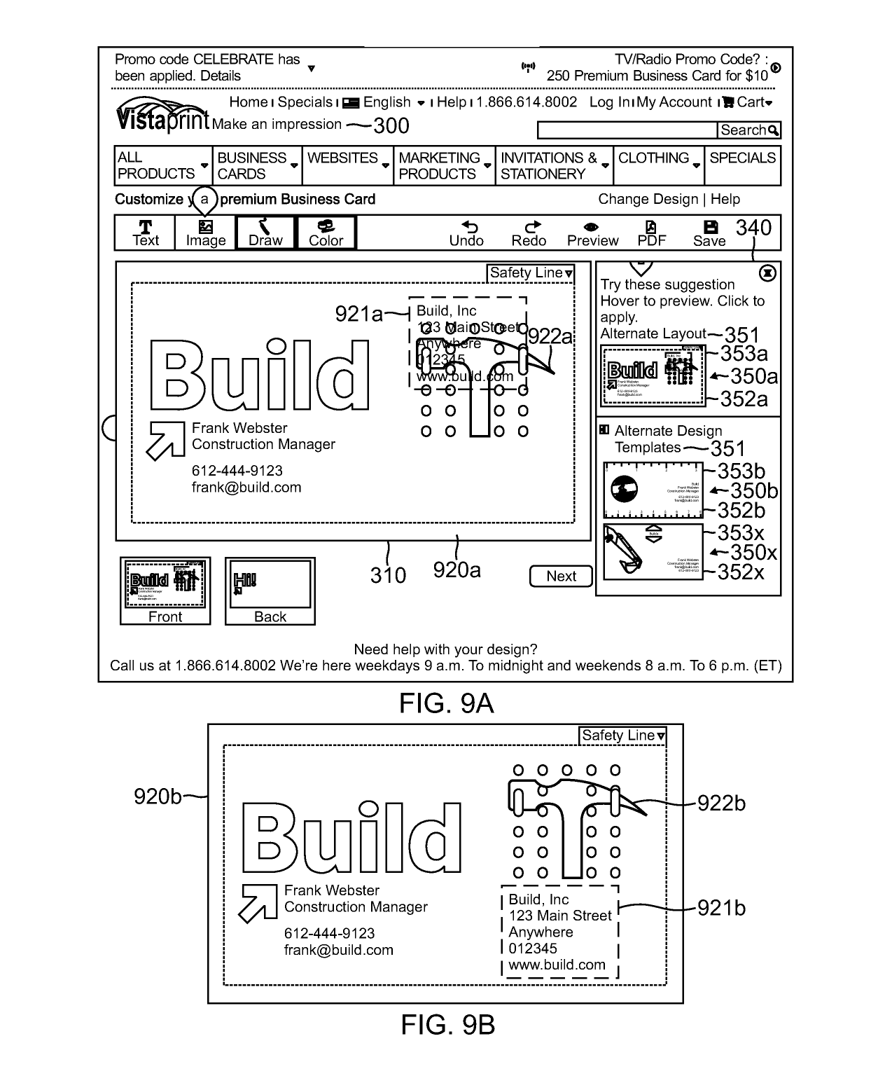

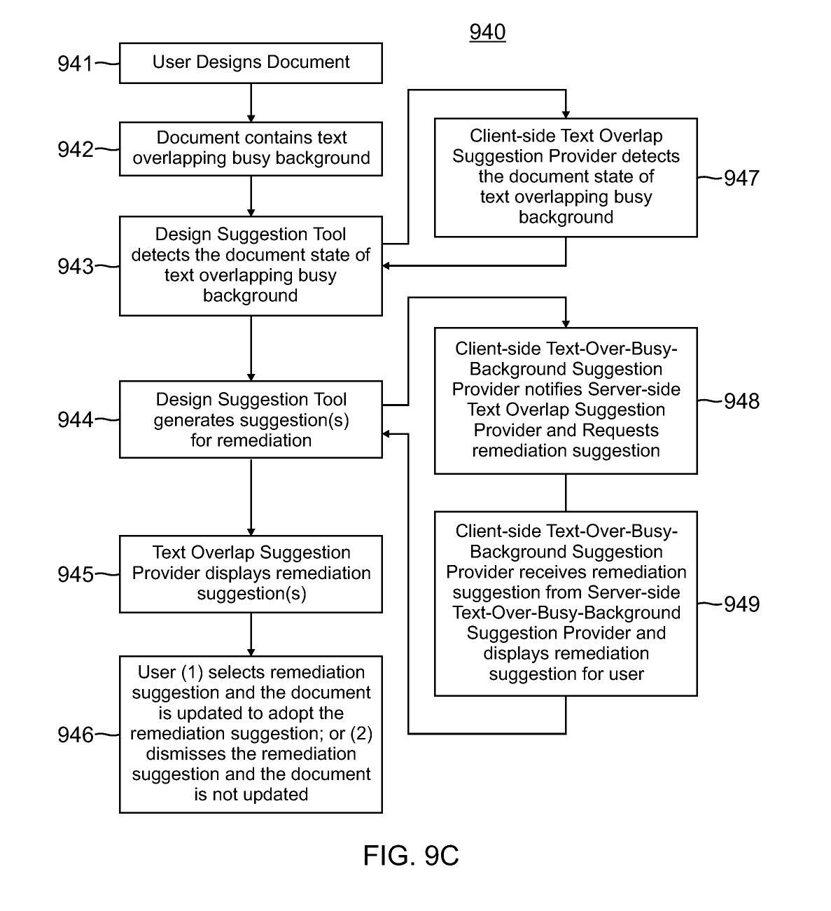

FIGS. 9A-9C illustrate a use case for a suggestion provider which detects a condition of text positioned over a busy background (and which may therefore be more difficult to perceive) in a user's design document and generates a corresponding remediation suggestion for the text over busy background condition. FIG. 9A illustrates an original design 920a that includes text components 921a positioned over a busy (high detail accompanied by low contrast areas) background 922a. Text component 921a is positioned over a busy background image 922a. The text is not very perceivable (i.e., it is difficult to read) due to the high detail and low contrast areas of the background image 922b. A better design may be to reposition at least one of the text component 921a and background image 922a such that the text component 921a does not overlap the busy background 922a. A suggestion provider 120 may be configured to detect a text against a busy background condition and to generate a suggestion in the form of a version of the original design in which text contrast conditions are corrected. FIG. 9B further illustrates an example suggested design in which the text components 921b (which corresponds to text component 921a from the original design 910a) have been repositioned below the busy background image 921b so as not to overlap the busy background 921b and to thus be more perceivable (i.e., readable).

FIG. 9C shows a flow diagram illustrating a use case for a suggestion provider which is configured to detect a condition of text against busy background and provide a suggestion which remediates the condition. As illustrated, a user creates a visual design in the form of a document (step 941). During creation of the document, a text component is positioned over a busy background (step 942). A design suggestion tool detects a document state of containing text over a busy background (step 943). The design suggestion tool generates one or more suggestion(s) for remediating the text over busy background condition (step 944). The design suggestion tool displays the remediation suggestion(s) (step 945). The user either (1) selects a remediation suggestion via a selection control provided in connection with the displayed remediation suggestion, or (2) dismisses or ignores the remediation suggestion (step 946). When the user selects a remediation suggestion, the document is updated to implement the selected remediation suggestion; otherwise, the document is not updated.

In an embodiment, the design suggestion tool 100 includes a client-side text-over-busy-background suggestion provider which executes on the user's electronic device (i.e., the client device) and a server-side text-over-busy-background suggestion provider which executes on a remote server (i.e., the server device). In a preferred embodiment, the client-side text-over-busy-background suggestion provider performs the condition detection—that is, the client-side text-over-busy-background suggestion provider analyzes the current state of the document and determines whether a text-over-busy-background condition is present (step 947). In this embodiment, when the client-side text-over-busy-background suggestion provider detects a text-over-busy-background condition, the client-side text-over-busy-background suggestion provider notifies the server-side text-over-busy-background suggestion provider and requests a suggestion which remediates the condition (step 948). The server-side text-over-busy-background suggestion provider generates a suggestion for remediating the text-over-busy-background condition. In a preferred embodiment, the server-side text-over-busy-background suggestion provider analyzes the current document and repositions, in a modified version of the user's document, one or more text and/or graphical components of the document design to determine and select a text color with high contrast relative the background color over which the text component is positioned. In a preferred embodiment, the modified version of the user's document is saved at the server and a thumbnail image of the document design is generated for use in displaying the modified version of the user's document in the suggestion panel 340 of the graphical user interface 300. The client-side text-over-busy-background suggestion provider receives the remediation suggestion from the server-side text-over-busy-background suggestion provider and displays the suggestion (step 949). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

Below is pseudo-code illustrating an exemplary embodiment of a text-over-busy-background algorithm:

Test-Over-Busy-Background Pseudocode:

```
  Given a design, model as a tree graph
  Loop through all text nodes top to bottom, left to right
    if text node is off canvas, ignore
    if text node is monogram, ignore
    if text node has a shadow, ignore
    if text node has a text-over-background problem
      determine distance of text node from top, bottom, left, right
      scan top to bottom for a safe location to move node to resolve
text-over-background problem
      prioritize for minimum distance displacement taking into account
distance of text node from top and bottom
      scan left to right for a safe location to move node to resolve
text-over-background problem
      prioritize for minimum distance displacement taking into account
distance of text node from left and right
      select the minimum possible displacement move between
top-to-bottom shift and left- to-right shift
      if shifting top to bottom
        shift up or down by minimum displacement distance
        depending on move direction
      else
        shift right or left by minimum displacement distance
        depending on move direction
      end if
    end if
  End Loop
```

In general, in order to detect the text-over-busy-background condition, the system renders the document design as a bitmap image, then scans the rendered bitmap to detect contiguous regions for purposes of determining shapes, caching the shape distribution knowledge. During the analysis phase by the text-over-busy-background suggestion provider, a text component's position is compared against known shape positions to determine if field overlaps a background shape. A detailed description of exemplary systems and methods for detecting whether text overlaps a busy background image is found in U.S. Pat. No. 8,588,529 issued Nov. 19, 2013, entitled, “Method And System For Detecting Text In Raster Image”, which is herein incorporated by reference for all that it teaches.

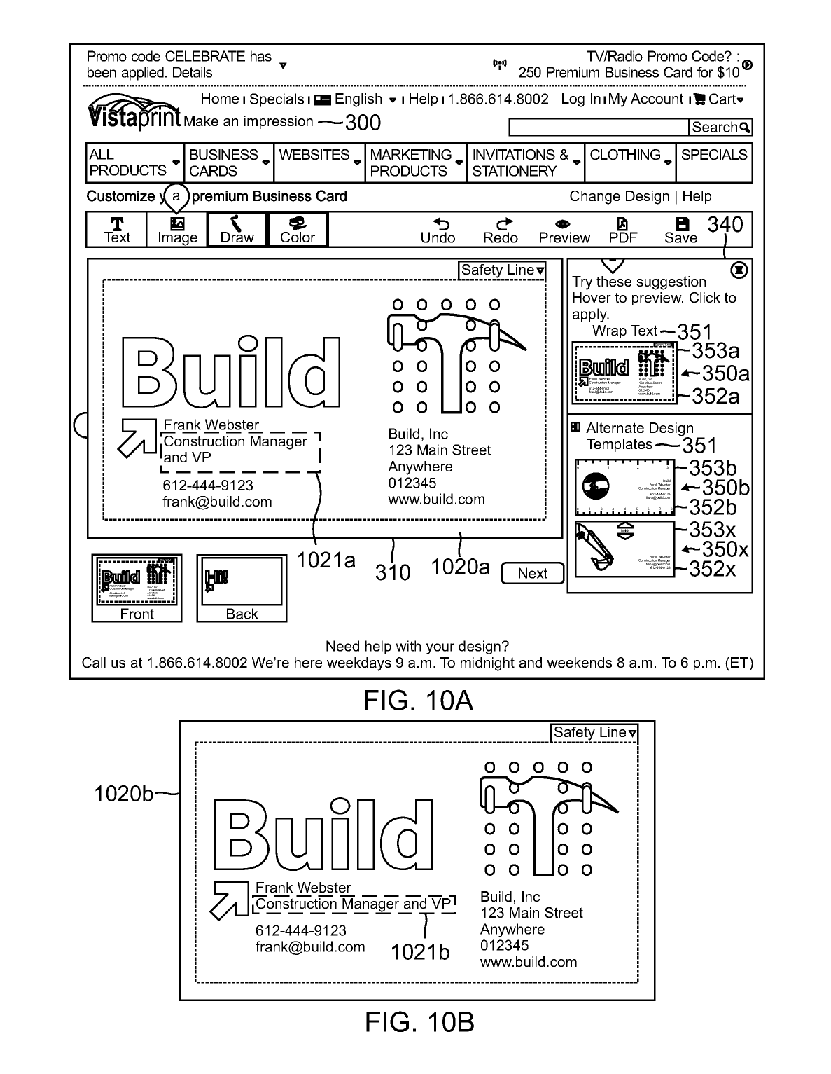

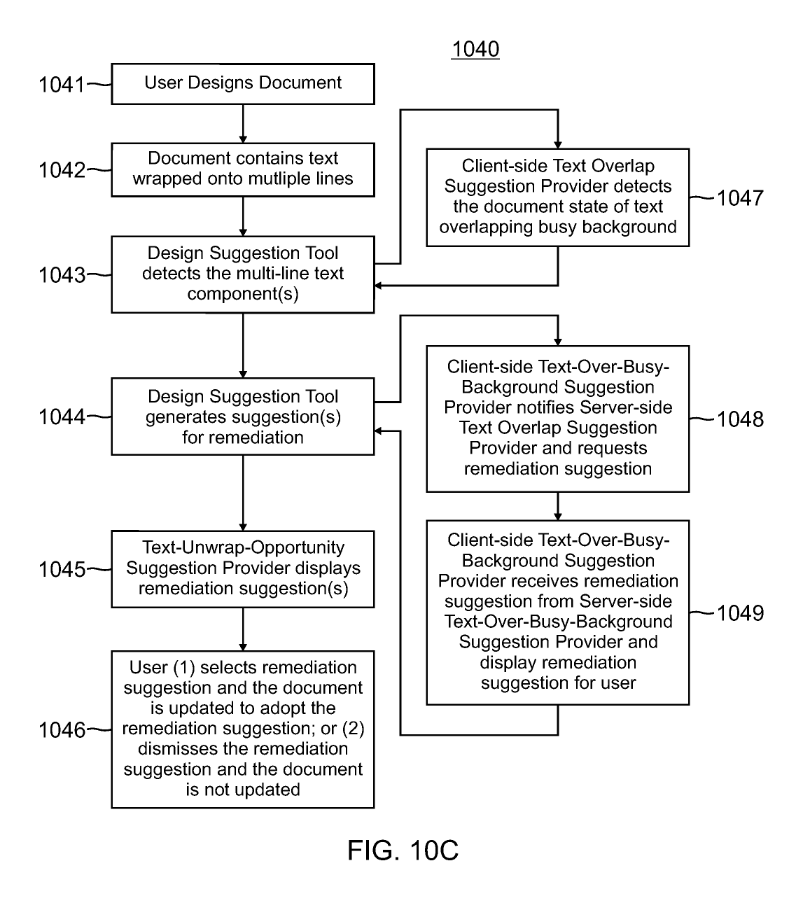

FIGS. 10A-10C illustrate a use case for a suggestion provider which detects an opportunity to consolidate, or “unwrap”, text components that occupy multiple lines in a user's design document into a fewer number of lines and generates a corresponding remediation suggestion. FIG. 10A illustrates an original design 1010a that includes a text component 1021a which occupies more than one line in the design document 1020a. A suggestion provider 120 may be configured to detect text overlaps and to generate a suggestion in the form of a version of the original design in which the text component 1021a has been unwrapped to occupy fewer lines (in the illustrated case, a single line). FIG. 10B illustrates an example suggested design in which the text component 1021b has been consolidated onto a single line.

FIG. 10C shows a flow diagram illustrating a use case for a suggestion provider 520 which is configured to identify multi-line text consolidation opportunities and to provide a suggestion for implementing one or more of the identified multi-line text consolidation opportunities. As illustrated, a user creates a visual design in the form of a document (step 1041). During creation of the document, one or more of the text components in the design wraps onto one or more additional lines (step 1042). A design suggestion tool detects the state of multi-line text components in the document (step 1043). The design suggestion tool generates one or more suggestion(s) for unwrapping the multi-line text component(s) (step 1044). The design suggestion tool displays the remediation suggestion(s) (step 1045). The user either (1) selects a remediation suggestion via a selection control provided in connection with the displayed remediation suggestion, or (2) dismisses or ignores the remediation suggestion (step 1046). When the user selects a remediation suggestion, the document is updated to implement the selected remediation suggestion; otherwise, the document is not updated.

In an embodiment, the design suggestion tool 100 includes a client-side text-unwrap-opportunity suggestion provider which executes on the user's electronic device (i.e., the client device) and a server-side text-unwrap-opportunity suggestion provider which executes on a remote server (i.e., the server device). In a preferred embodiment, the client-side text-unwrap-opportunity suggestion provider performs the condition detection—that is, the client-side text-unwrap-opportunity suggestion provider analyzes the current state of the document and determines whether an opportunity for unwrapping a multi-line text component exists (step 1047). In such an embodiment, when the client-side text-unwrap-opportunity suggestion provider detects an opportunity for unwrapping a multi-line text component, the client-side text-unwrap-opportunity suggestion provider notifies the server-side text-unwrap-opportunity suggestion provider and requests a suggestion which remediates the condition (step 1048). The server-side text-unwrap-opportunity suggestion provider generates a suggestion for unwrapping a multi-line text component. In a preferred embodiment, the server-side text-unwrap-opportunity suggestion provider analyzes the current document and repositions, in a modified version of the user's document, one or more text components in the document design so that the text components in document do not overlap. In a preferred embodiment, the modified version of the user's document is saved at the server and a thumbnail image of the document design is generated for use in displaying the modified version of the user's document in the suggestion panel 340 of the graphical user interface 300. The client-side text-unwrap-opportunity suggestion provider receives the remediation suggestion from the server-side text-unwrap-opportunity suggestion provider and displays the suggestion (step 1049). In a preferred embodiment, the received remediation suggestion comprises the thumbnail image of the modified version of the user's document in order to illustrate to the user how the remediation suggestion affects the appearance of the user's document and to allow the user to have the system automatically incorporate the suggestion if the user selects the suggestion.

In an embodiment, the text-unwrap-opportunity suggestion provider may be implemented according to the following pseudocode:

Text Unwrapping - Pseudo-code:

```
  Given a design, model design as graph
    Create logical groupings for text components based on spatial
    distance between fields
    Loop through all text groupings
      Loop through all text nodes in text grouping
        if text node has 2 lines of wrapped text and can be intelligently
        fixed, fix move up other fields in text group to account for space
created by collapsing the wrapped text to 1 line
      End Loop
    End Loop
```

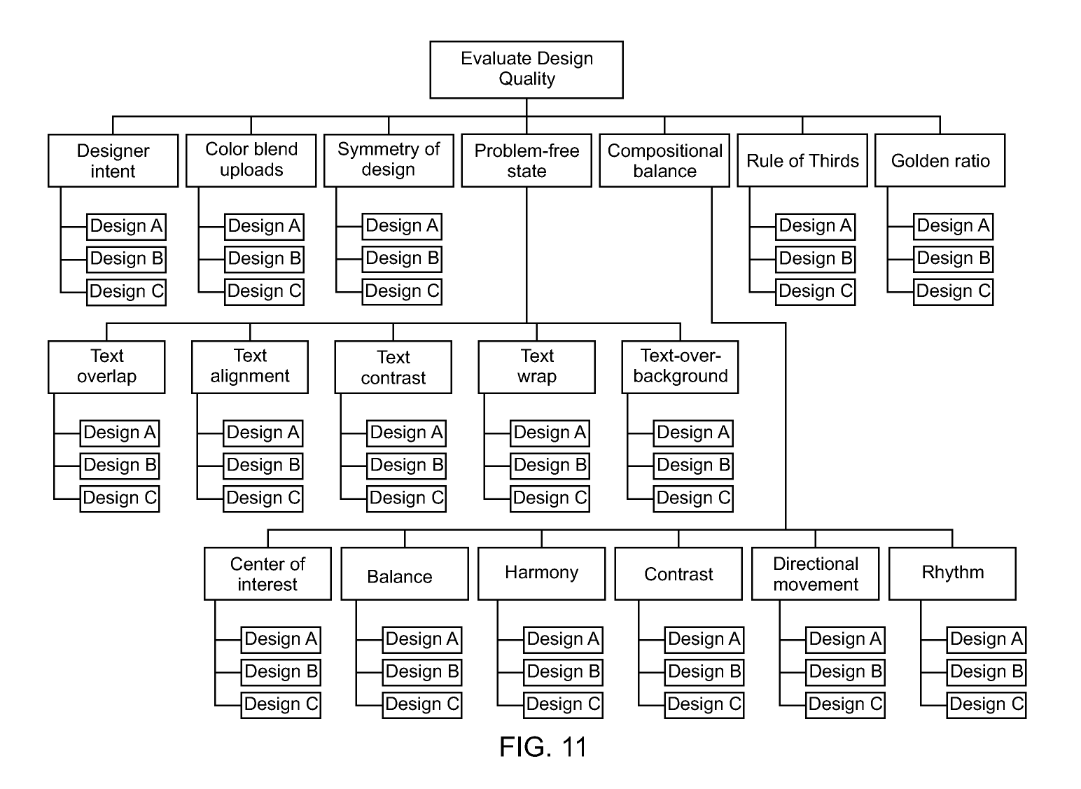

Returning once again to FIG. 1, in general the design suggestion tool 100 is configured with a number of different suggestion providers 120a, 120b, . . . , 120n which analyze an input design 101 with respect to a number of factors in accordance with the universally-accepted good design principles discussed above. FIG. 11 represents the problem of evaluating the quality of a given design in an hierarchical diagram. As noted therein, the quality of a design 101 is measured against a plurality of factors, some of which can be measured objectively (e.g., does the design use the “Golden Ratio” (or “phi”) for each of the blocks of components, does the design include text that overlaps other text or a busy background, etc.), and some of which are more subjective measurements that can only be inferred (e.g., inferring the designer's intent based on the positions and relative sizes of the content, does there appear to be a center of interest or directional movement, etc.). In order to ensure a design maximizes each of the universally-accepted good design principles, the suggestions generated by each of the suggestion providers 120a, 120b, . . . , 120n should be taken into account, and combined if possible. That is, checks should be made by, and suggestions taken from, individual suggestion providers to ensure a problem-free state of the design (e.g., no text overlap, good text-to-background contrast, no text over busy background, alignment of grouped components, etc.), and further checks and suggestions from suggestion providers suggesting enhancements to improve the layout, the coloring, the balance and harmony and/or directional movement, of the design, should also be considered and applied where it best makes sense.

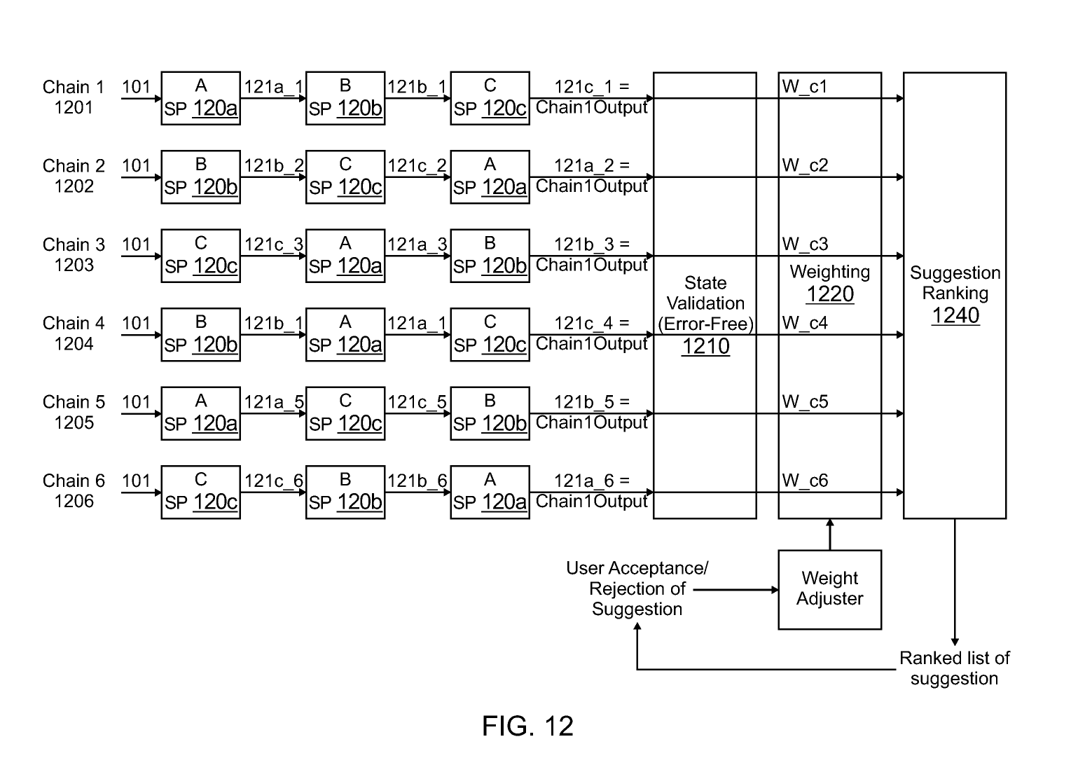

In order to achieve high quality yet provide as full automation as possible to achieve a high-quality design without too much back and forth between the system and the user, the suggestion providers may be linked in various configurations, so that the output of one suggestion provider may be the input of a next suggestion provider in the chain. In an embodiment, the different suggestion providers are serially linked in a particular order, and the order of the links between the suggestion providers in each chain is different than the order of any other chain. For example, suppose there are three suggestion providers, 120a, 120b, 120c, as shown in FIG. 12 (and, labeled A, B, C for convenience of explanation). The suggestion providers A, B, and C, may correspond, for example, to the suggestion providers 120a, 120b, 120c in FIG. 1. Typically, there will be many more suggestion providers 120, but for ease of explanation, only three are considered in the present discussion. Since there are three suggestion providers, there exist 3-factorial (3!), or six, combinations of different serially linked configurations of chains: ABC (labeled Chain 1), BCA (labeled Chain 2), CAB (labeled Chain 3), BAC (labeled Chain 4), ACB (labeled Chain 5), CBA (labeled Chain 6).

In a given chain of ordered suggestion providers, a design 101 is processed by the first ordered suggestion provider in the chain, and its output becomes the input to the second suggestion provider in the chain. The output of the second suggestion provider in the chain then becomes the input to the third suggestion provider in the chain, and so on and so forth until the last suggestion provider in the chain generates an output. Referring to FIG. 12, for example, the input design 101 is processed first by suggestion provider 120a A to generate an alternative version 121a_1, which is then processed by suggestion provider 120b B to generate alternative version 121b_1, which is then processed by suggestion provider 120c C to generate alternative version 121c_1, or the output Chain1Output of Chain 1. Chain 2 processes the input design 101 in a similar manner, except that the order of processing is B, A, C, generating intermediate alternative versions 121b_2, 121c_2, and the final output Chain2Output as 121a_2. The remaining chains Chain 3, Chain 4, Chain 5 and Chain 6 process the input design 101 in a similar manner, except that the order of processing by the suggestion providers 120a A, 120b B, and 120c C, is different for each chain.

As just described, each suggestion provider may generate a suggestion in the form of an alternative design 121a_x, 121b_x, 121c_x (where x indicates the chain identifier (Chain 1, Chain 2, . . . , Chain 6), and a, b, c corresponding to the particular suggestion provider A, B, or C that processed the input—refer to FIG. 12) which is then used as input to the next ordered suggestion provider in the chain. Because each suggestion provider, A 120a, B 120b, C 120c, validates the design, and remediates or generates alternative suggested designs, with respect to a different design aspect, the output design of a given suggestion provider is changed only with regard to that particular design aspect. Because the order by which the design is processed by the suggestion providers is different for each chain, changes made to a design by a suggestion provider early in the chain may trigger different changes by suggestion providers further down the chain. Since each change to the design by a suggestion provider 120 is made without regard to the other aspects of the design, any given change to the design may trigger a remediation/suggestion when processed by a suggestion provider further down the chain.

In each chain, the suggested alternative design may change in different ways as it is processed by each suggestion provider in the chain. For example, suppose the suggestion provider A performs text overlap validation and remediation, and suggestion provider B performs text contrast validation and remediation, and suggestion provider performs the text-over-busy-background validation and remediation. In Chain 1, the suggestion provider order is ABC. Thus, suggestion provider A performs text overlap validation/remediation on the input design 101. Suppose in this example that suggestion provider A, receiving as input design 101, generates an alternative design 121a_1 suggesting the move of a text component. Suppose in this example a first text component is moved to prevent text overlap, and is moved to a first position over a background with low contrast. Suggestion provider B then performs text contrast and generates an alternative design 121b_1 suggesting the move of the first text component to a second position that is good (that is, the first text component positioned in the second position does not trigger a poor text contrast condition). Continuing with the example, suggestion provider C then performs text-over-busy background detection and remediation, and ends up moving a second text component to third location.

Meanwhile, continuing with the example, in Chain 2, the suggestion provider order is BCA. Suggestion provider B performs text contrast validation first and does not detect a problem and does not modify the design. Suggestion provider C then performs text-over-busy-background and moves a third text component to a fourth location. Suggestion provider A then performs text overlap validation and does not detect a problem. The Chain1 Output alternative design is thus different than the Chain2Output design. In general, each chain may generate a different final alternative design suggestion.

When a design suggestion is generated, it is preferable that the suggested alternative design is error-free (i.e., does not contain text overlap, has suitable text contrast, does not contain text over a busy background, etc., i.e., “error conditions”). Accordingly, a State Validator 1210 may perform a final validation on the final suggested alternative design Chain1Output, Chain2Output, . . . , Chain3Output output by each chain Chain 1, Chain 2, . . . , Chain 6 to determine whether any of the error conditions exist in the respective suggested alternative design. The State Validator 1210 may perform many of the same condition detection checks as do some of the suggestion providers 120 (e.g., text overlap detection, poor text contrast detection, text-over-busy-background detection, etc.) but does not modify the chain output designs Chain1Output, Chain2Output, . . . , Chain3Output. If one of the state error conditions is detected in a given chain output design, that particular design is eliminated from the list of valid alternative designs. For example, suppose in the previous example that when the second text component is moved by suggestion provider C to a third location, the move introduces a text overlap condition. The State Validator 1210 will detect this condition and remove the Chain1Output from the list of suggested alternative designs that could potentially be presented to the user.

The different alternative designs may be further analyzed to rank the alternatives, and the highest-ranking alternative designs may be selected for recommendation and/or presentation to the user. In an embodiment, ranking is achieved using a dynamically adjusted chain weighting engine which includes a weight matrix 1220 and a weighting adjuster 1230 which monitors which chain's suggestions are accepted by the user, and which chain's suggestions are rejected (i.e., not accepted) by the user or which were ultimately eliminated by the State Validator 1210 from the list of potential suggestions that could be presented to the user. Initially, the weights w_c1, w_c2, . . . , w_c6 corresponding to each chain are set to be of equal weight. Then, each time a suggestion event is triggered, the weight associated with each chain that generated a chain output that is found by the State Validator 1210 to violate one of the error conditions is reduced to have a relatively lower weight than before in or order to reflect that the chain does, at least occasionally, product output that is not error-free.

Then, for each chain output selected for presentation to the user, the weight adjuster 1230 increases the associated weight(s) for the suggestions(s) accepted by the user, and reduces the respective weight(s) of the chains associated with the presented suggestions that were not accepted by the user.

Over time, chains which consistently produce suggestions adopted by the user will end up with relatively high weights, and the corresponding confidence level that a suggestion generated by such chain with high weighting will be adopted by the user, if presented to the user, is also high. Correspondingly, suggestions generated by chains with high weightings are ranked higher by the Suggestion Ranking engine 1240, and are more likely to be selected for presentation to the user.

In contrast, chains which consistently produce suggestions that get eliminated by the State Validator 1210, or which pass the State Validator 1210 but do not get accepted by the user when presented to the user, will end up with relatively low associated weights, and will be naturally “weeded out” based on user feedback.

The Suggestion Ranking engine 1240 ranks the list of error-free suggested alternative designs in order of confidence that a given suggested alternative design will be adopted by a user if actually presented to the user. Suggested alternative designs that were found by the State Validator 1210 to contain an error condition are not included in the ordered suggest list. The Suggestion Ranker 1240 orders the error-free suggested alternative designs in order of the weights associated with the chains from which they were produced—that is, suggestions produced by the chain with the highest associated chain weight to the chain with lowest associated chain weight. If the graphical user interface suggestion panel 340 (FIG. 3) has space for only three suggestions, the three top-ranked suggested alternative designs are selected for presentation in the panel 340 for consideration by the user.

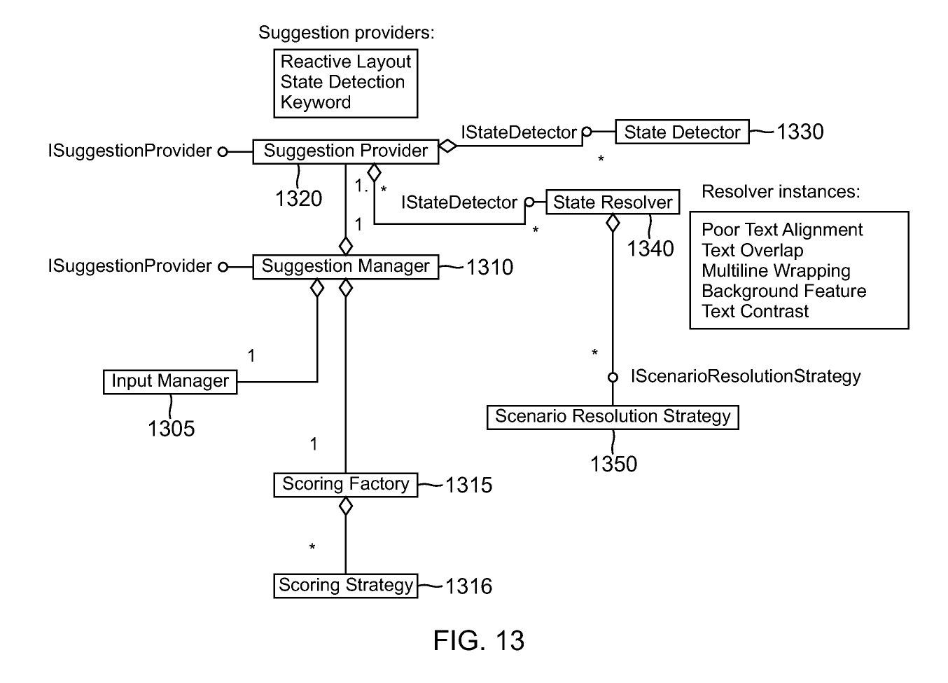

FIG. 13 is a relational architectural diagram illustrating an example of a high-level implementation of a design suggestion tool 100. The classes include a Suggestion Manager 1310, a Suggestion Provider 1320, a State Detector 1330, a State Resolver 1340, a Scenario Resolution Strategy 1350, an Input Manager 1305, a Scoring Factory 1315, and a Scoring Strategy 1316.

In relational terms, the Suggestion Manager 1310 has an Input Manager 1305, has a Scoring Factory 1315, and has a Suggestion Provider 1320. The Suggestion Provider 1320 has a State Detector 1330 and has a State Resolver 1340. The State Resolver 1340 has a Scenario Resolution Strategy 1350.

The Suggestion Manager 1310 is invoked upon the occurrence of certain events in the visual design tool 50. Example types of events that may cause the Suggestion Manager 1310 to be invoked may include an event involving the moving by a user of an element (a mouse-click-down event, followed by a mouse-drag event, followed by a mouse-click-up event), or the adding or removal by the user of an element.

When the Suggestion Manager 1310 is invoked, it instantiates a Suggestion Provider 1320. There may be different types of suggestion providers—for example (1) State based detection and remediation; (2) Monolithic remediation; and (3) Keyword or Content based.

State based suggestion providers detect a particular condition in the design on a component-by-component basis and remediates the design on a component-by-component basis only (i.e., without consideration that the remediation may have introduced problems or error conditions relative to a different aspect of the design). Examples of State based suggestion providers are the text overlap suggestion provider, the poor text contrast suggestion provider, the text-over-busy-background suggestion provider, described above.

Monolithic suggestion providers evaluate a document design overall and adjusts the design on an overall basis, possibly adjusting multiple components in the design, to attempt to create an alternative design that is error-free by considering the effects of a change on multiple components simultaneously. An example of a Monolithic suggestion provider is a suggestion provider that performs automated self-adjusting component layout, for example as described in detail in US Patent Publication US20130254655 published Sep. 26, 2013, which is herein incorporated by reference for all that it teaches, and which generates an energy model of the layout of the user-content components in a user design document based on original positions and sizes of the user-content components in an original template document from which the user design document is based, and which automatically adjusts positions of components in the user design document as the user edits the document to minimize the energy of the user-content component layout.

Keyword, or Content, based suggestion providers propose suggestions based on detection of keywords in the user-provided/selected content of the design, or in aspects (such as color) of user-provided/selected content such as images. An example of a Keyword based suggestion provider may be one that detects a word in the user-inserted content, searches a database of images having associated keyword tags to find alternative images tagged with the detected word as the keyword, and inserts an image, or swaps out an existing image, in the design as a suggested alternative image. Another example is the Color Variation suggestion provider described above, which analyzes the user design to determine dominant and secondary colors in the design, and recolors various components of the design to generate a color variation of the original design.

Returning to FIG. 13, the State Detector 1330 detects what has happened on the canvas (i.e., the work area 310 in the GUI—see FIG. 3). The State Detector 1330 reports back what in the document has been changed. The State Detector 1330 can be informed by information coming in from the client (for example, change reporting from the visual design tool 50 executing at the user electronic device 420).

Once the State Detector 1330 has detected a user modification to the current design 320 in the work area 310, the State Resolver 1340 loads in a set of plugins—instances of State Resolver 1340. Instances of State Resolver 1340 are invoked by the Suggestion Provider 1320 in a chain ordering, such as the chains Chain 1, Chain 2, . . . , Chain 6, described in FIG. 12. Each instance of a State Resolver 1340 has a different function. The State Resolver 1340 has different strategies it can employ. For example, in the case that there are multiple ways to handle contrast, the Contrast State Resolver 1340 has multiple strategies it can employ. Each State Resolver 1340 has one or more strategies. The strategies can be individually weighted, and based on feedback from the user input it is possible to ascertain whether one strategy results in higher user acceptance than other strategies, which would inform future strategy decisions in favor of certain strategies over others.

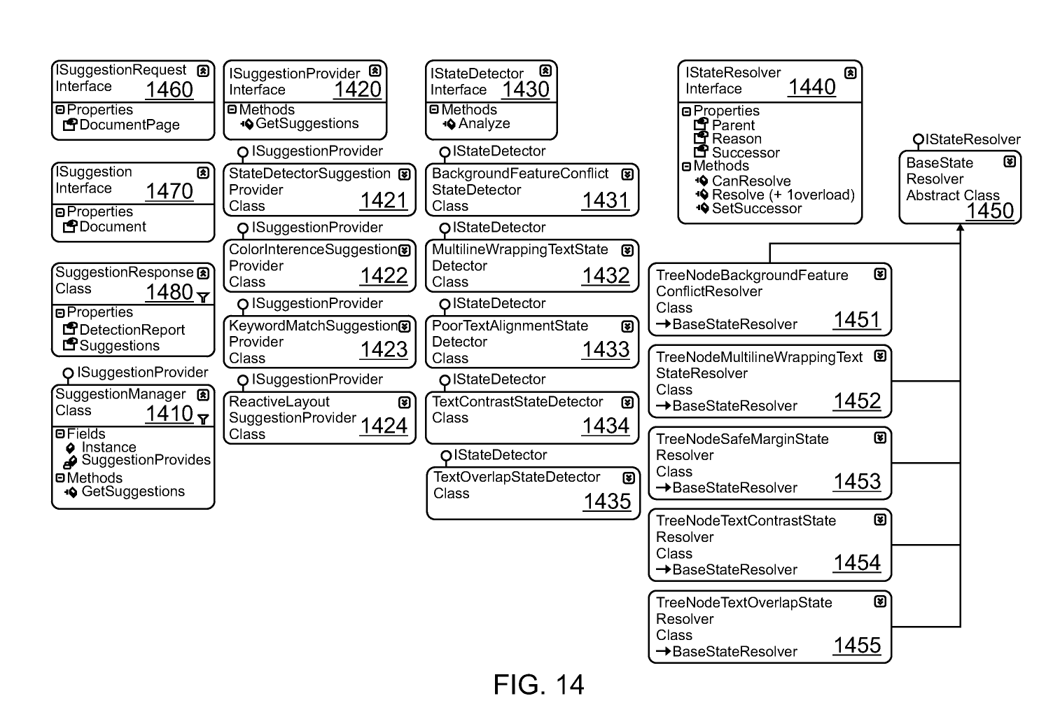

FIG. 14 illustrates a class diagram corresponding to the relational architectural diagram of FIG. 13. As illustrated, the Suggestion Manager 1310 is an instance of a SuggestionManager class 1410, which has different Suggestion Providers and can get suggestions (method GetSuggestions). As further illustrated, the suggestion provider 1320 is an instance of suggestion provider interface ISuggestionProvider 1420, which may include instances of different types of suggestion providers, such as a state detector suggestion provider (StateDetectorSuggestionProvider class 1421), a color variation suggestion provider (ColorInferenceSuggestionProvider class 1422), a keyword or content based suggestion provider (KeywordMatchSuggestionProvider class 1423), and a monolithic suggestion provider (ReactiveLayoutSuggestionProvider class 1424). The State Detector 1330 is interface IStateDetector 1430, which may include a number of state detection classes, including BackgroundFeatureConflictStateDetector class 1431, MultilineWrappingTextStateDetector class 1432, PoorTextAlignmentStateDetector class 1433, TextContrastStateDetector class 1434, and TextOverlapStateDetector class 1435. The State Resolver 1340 is an interface IStateResolver 1440, which may include a number of state resolver classes, including a base resolver class BaseStateResolver class 1450, a TreeNodeBackgroundFreatureConflictResolver class 1451, a TreeNodeMultilineWrappingTextStateResolver class 1452, a TreeNodeSafetyMarginStateResolver class 1453, a TreeNodeTextContrastStateResolver class 1454, and a TreeNodeTextOverlapStateResolver class 1455. Interfaces ISuggestionRequest 1460 and ISuggestion 1470 and class SuggestionResponse 1480 are also implemented and used by the visual design tool 50 to interface with the design suggestion tool 100.

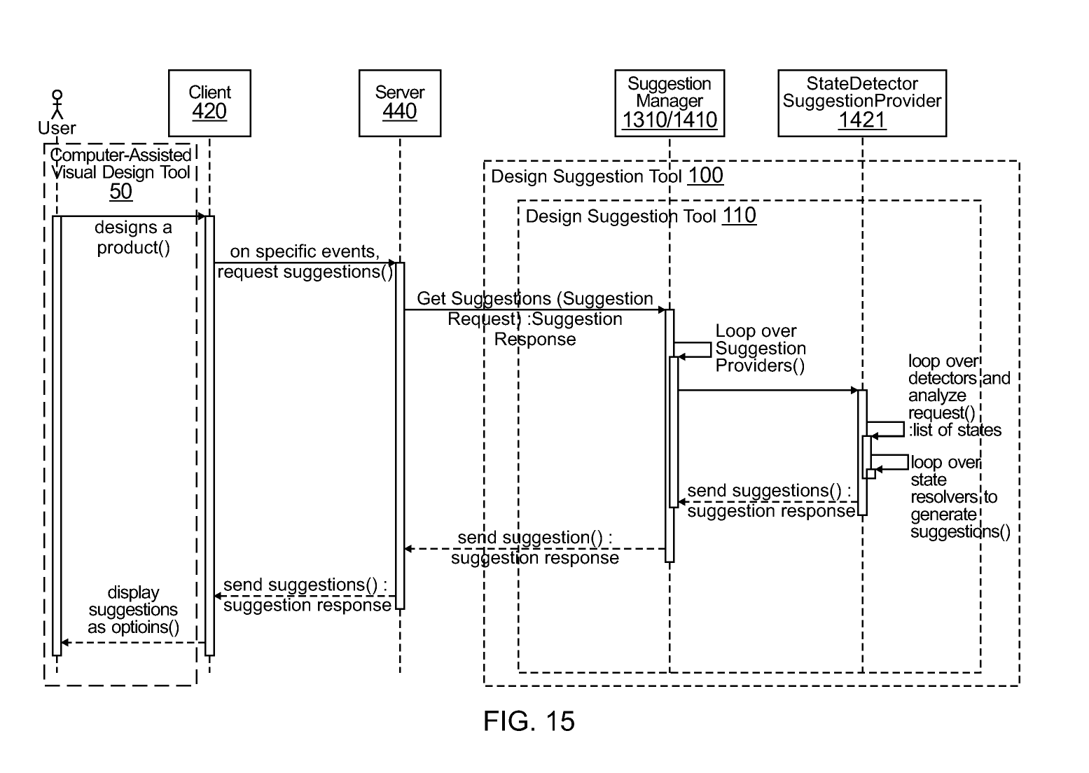

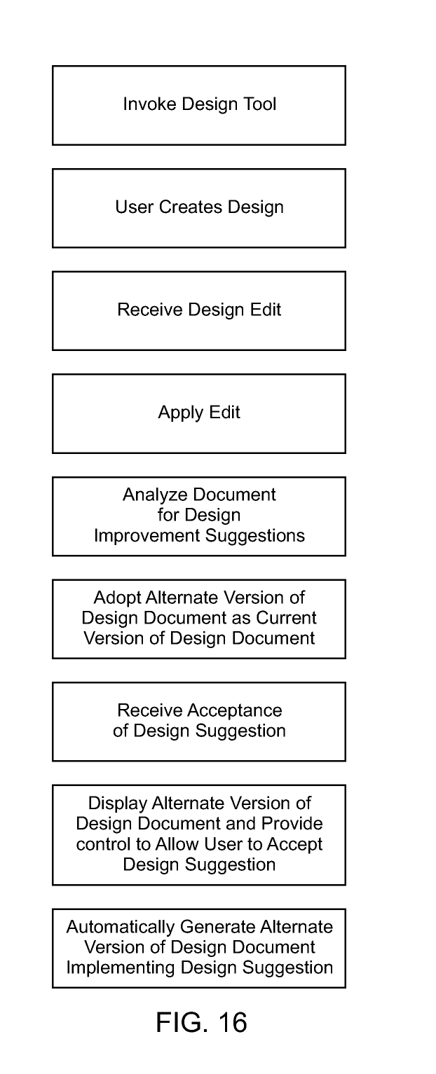

FIG. 15 is an operational sequence diagram, illustrating one implementation of how events are sequenced in an embodiment of the invention. In this embodiment, a computer-assisted visual design tool 50 is accessed and used through a GUI executing on a client computer 420, which interacts with a design suggestion tool 100 executing on a server computer 440. The design suggestion tool 100 includes a design suggestion engine 110, which implements a suggestion manager 1310/1410, and a state detector suggestion provider 1421. FIG. 16 illustrates the flow of operation.

As illustrated in FIGS. 15 and 16, a user invokes the design suggestion tool (step 1610). A user creates a design (step 1612). On specific events, such as insertion, removal, repositioning or recoloring of an element, a request for a suggestion is generated, which invokes an instance of the SuggestionManager 1410. The SuggestionManager 1410 may invoke an instance of a StateDetectorSuggestionProvider 1421, which may invoke, in a chained relationship, a number of instances of different state detectors 1431-1435, and which may further invoke, in a chained relationship, a number of instances of different state resolvers 1451-1455. Suggestion responses are sent back, via the server 440 to the client 420 for display in the suggestion panel 340 of the visual design tool GUI.

In sum, the above detailed description and accompanying figures detail a comprehensive computer-assisted visual design tool which offers automated suggestions designed to be ones a user is most likely to adopt.

In an alternative mode of operation, the design suggestion tool 100 may be used independently of a computer-assisted visual design tool 50 in order to create at least one alternative design based on the content of another design. For example, occasionally it may be desired to place a design that was created for one product having a first set of dimensions onto a different product having a second different set of dimensions. In such cases, the design having the first set of dimensions may not fit or may not fill the target area having the second set of dimensions. The suggestion generation system may be used to create an alternative design that better fits the second set of dimensions, by setting the new dimensions, submitting the first design, and using the automated suggestion features of the system to suggest and automatically generate a better design for the new dimensions. As another example, the computer-automated design suggestion tool may be advantageously used to create alternative designs having the same or similar visual assets but having at least one variation on the visual assets (such as different color scheme, fonts, layouts, imagery, etc.), and/or different dimensions, which can be applied to different types and sizes of products.

What is claimed is:

1. A computer-automated design suggestion system, comprising:
at least one receiving processor which receives an electronic document representing a visual design,
at least one analysis processor which analyzes the visual design to identify one or more design improvement suggestions for the visual design, and generates an indication of at least one of the design improvement suggestions, the design improvement suggestions comprising at least one of a format improvement suggestion determined from the format of the visual design and a design content improvement suggestion determined from the content of the visual design.

2. The system of claim 1, comprising:
at least one user interface processor which displays the indication on an electronic display.

3. The system of claim 1, wherein the at least one analysis processor applies at least one of the design improvement suggestions to the visual design to generate an alternative visual design which incorporates the applied design improvement suggestions.

4. The system of claim 3, wherein the indication of at least one of the design improvement suggestions comprises the alternative visual design.

5. The system of claim 4, comprising:
at least one user interface processor which provides a user interface and displays the indication on an electronic display.

6. The system of claim 5, wherein the at least one user interface processor displays the received visual design together with the indication on the electronic display.

7. The system of claim 6, wherein the at least one user interface processor is responsive to a user input control which allows the user to indicate user acceptance of one or more of the design improvement suggestions indicated in the displayed indication and which upon receipt of user acceptance via the user input control automatically applies the indicated accepted design improvement suggestions to the visual design.

8. The system of claim 6, wherein the indication of the design improvement suggestions is presented dynamically while the visual design is being edited by a user via the user interface.

9. The system of claim 1, wherein the indication of at least one of the design improvement suggestions comprises at least a text description of a design improvement suggestion.

10. The system of claim 9, comprising:
at least one user interface processor which provides a user interface and displays the indication on an electronic display.

11. The system of claim 10, wherein the at least one user interface processor displays the received visual design together with the indication on the electronic display.

12. The system of claim 11, wherein the at least one user interface processor is responsive to a user input control which allows the user to indicate user acceptance of one or more of the design improvement suggestions indicated in the displayed indication and which upon receipt of user acceptance via the user input control automatically applies the indicated accepted design improvement suggestions to the visual design.

13. The system of claim 11, wherein the indication of the design improvement suggestions is presented dynamically while the visual design is being edited by a user via the user interface.

14. The system of claim 1 wherein at least one of the design improvement suggestions comprises a text overlap condition remediation suggestion for remediation of a text overlap condition detected in the visual design.

15. The system of claim 1 wherein at least one of the design improvement suggestions comprises a poor text alignment condition remediation suggestion for remediation of a poor text alignment condition detected in the visual design.

16. The system of claim 1 wherein at least one of the design improvement suggestions comprises a color variation suggestion for implementing a color variation of the visual design.

17. The system of claim 1 wherein at least one of the design improvement suggestions comprises a poor text contrast condition remediation suggestion for remediation of a poor text contrast condition detected in the visual design.

18. The system of claim 1 wherein at least one of the design improvement suggestions comprises a remediation suggestion for remediation of detected text positioned over a busy background in the visual design.

19. The system of claim 1 wherein at least one of the design improvement suggestions comprises a remediation suggestion for unwrapping text components that occupy multiple lines in the visual design.

20. A design tool for creating visual designs, comprising:
a user interface processor which presents a user interface on an electronic display, the user interface comprising a work area which displays a visual design, at least one editing control allowing a user to edit the visual design, and a design assistant area responsive to a suggestion processor to receive and display at least one design improvement suggestion;
wherein the suggestion processor is configured to analyze the visual design displayed in the work area to identify one or more design improvement suggestions for the visual design, and to generate an indication of at least one of the design improvement suggestions, the design improvement suggestions comprising at least one of a format improvement suggestion determined from the format of the visual design and a design content improvement suggestion determined from the content of the visual design.

21. The design tool of claim 20, the user interface further comprising at least one user input control, the user input control responsive to user input indicating user acceptance of one or more of the design improvement suggestions indicated in the design assistant area to automatically apply the indicated accepted design improvement suggestions to the visual design in the work area.

22. A design improvement suggestion system for analyzing a visual design represented in an electronic document, comprising:
electronic storage memory storing the electronic document;
at least one suggestion engine processor executing a suggestion engine process which invokes one or more suggestion provider processes;
at least one suggestion provider processor which executes one or more of the invoked suggestion provider processes, each invoked suggestion provider process independently analyzing the visual design and measuring the visual design against different respective sets of one or more of design aspects to determine possible design improvements relative to the respective set of design aspects and to generate corresponding design improvement suggestions associated with the determined possible design improvements;
wherein the at least one suggestion engine selects at least one design improvement suggestion generated by the invoked suggestion provider processes and generates an indication of the selected at least one design improvement suggestion.

23. The design improvement suggestion system of claim 22, wherein:
each invoked suggestion provider process comprises a chain of individual suggestion provider processes, the first individual suggestion provider process in the chain analyzing the visual design represented in the electronic document, an each subsequent individual suggestion provider process analyzing a modified visual design as modified by the preceding individual suggestion provider process in the chain, and the last suggestion provider process in the chain producing the corresponding design improvement suggestion associated with the invoked suggestion provider process, and where each individual suggestion provider process performs its analysis based on a different design aspect.
